(19) United States
(12) Patent Application Publication
(10) Pub. No.: US 2025/0373751 A1
(43) Pub. Date: Dec. 4, 2025

(54) GENERATING A CAMERA TRAJECTORY FOR A NEW VIDEO

(71) Applicant: Apple Inc., Cupertino, CA (US)

(72) Inventors: Dan Feng, Cupertino, CA (US); Daniel Knowlton, Pasadena, CA (US); Jee Young Park, San Bruno, CA (US); Lee D. Kerley, Santa Clarita, CA (US); Phankham Wiantrakoon, Los Angeles, CA (US); Raymond T. Stewart, Stone Mountain, GA (US)

(21) Appl. No.: 19/170,879

(22) Filed: Apr. 4, 2025

Related U.S. Application Data
(60) Provisional application No. 63/654,549, filed on May 31, 2024.

(51) Int. Cl. H04N 5/222; G06T 7/70; H04N 23/60; H04N 23/63

(52) U.S. Cl. CPC H04N 5/2228; G06T 7/70; H04N 23/632; H04N 23/64

(57) ABSTRACT

A method includes receiving a request that specifies a desired cinematic experience for an environment. The method includes obtaining sensor data that indicates environmental characteristics of the environment and camera parameters of a set of one or more cameras. The method includes determining, based on the environmental characteristics and the camera parameters, a target cinematic shot that provides the desired cinematic experience. The method includes displaying a cinematic shot guide for capturing the target cinematic shot.

### CROSS-REFERENCE TO RELATED APPLICATION

This application claims the benefit of U.S. Provisional Patent App. No. 63/654,549, filed on May 31, 2024, which is incorporated by reference in its entirety.

### TECHNICAL FIELD

The present disclosure generally relates to generating a camera trajectory for a new video.

### BACKGROUND

Some devices include a camera for capturing videos. Some such devices include a camera application that presents a graphical user interface for controlling certain aspects of the camera. For example, the graphical user interface may include an option to turn a flash on or off while the camera captures images. While cameras of most devices have the ability to capture images of sufficient quality, most graphical user interfaces do not facilitate the capturing of certain cinematic shots.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1O are diagrams of an example environment in accordance with some implementations.

FIG. 2 is a block diagram of a system that generates a target camera trajectory in accordance with some implementations.

FIG. 3 is a flowchart representation of a method of generating a target camera trajectory in accordance with some implementations.

FIG. 4 is a block diagram of a device that generates a target camera trajectory in accordance with some implementations.

FIGS. 5A-5B are diagrams of an example environment in accordance with some implementations.

FIGS. 5C-5H are diagrams of an example user interface in accordance with some implementations.

FIG. 6 is a block diagram of a system that displays a cinematic shot guide in accordance with some implementations.

FIG. 7 is a flowchart representation of a method of displaying a cinematic shot guide in accordance with some implementations.

FIG. 8 is a block diagram of a device that displays a cinematic shot guide in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for generating a target camera trajectory for a new video. In some implementations, a device includes a display, an image sensor, a non-transitory memory, and one or more processors coupled with the display, the image sensor and the non-transitory memory. In various implementations, a method includes obtaining a request to generate a target camera trajectory for a new video based on an existing video. In various implementations, the method includes determining a set of one or more estimated camera trajectories that were utilized to capture the existing video based on an image analysis of the existing video. In various implementations, the method includes generating the target camera trajectory for the new video based on the set of one or more estimated camera trajectories that were utilized to capture the existing video and a model of an environment in which the new video is to be captured.

Various implementations disclosed herein include devices, systems, and methods for generating a cinematographic shot guide. In some implementations, a device includes a display, an image sensor, a non-transitory memory, and one or more processors coupled with the display, the image sensor and the non-transitory memory. In various implementations, a method includes receiving a request that specifies a desired cinematic experience for an environment. In some implementations, the method includes obtaining sensor data that indicates environmental characteristics of the environment and camera parameters of a set of one or more cameras. In some implementations, the method includes determining, based on the environmental characteristics and the camera parameters, a target cinematic shot that provides the desired cinematic experience. In some implementations, the method includes displaying a cinematic shot guide for capturing the target cinematic shot.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Many camera-enabled devices include a camera application that presents a graphical user interface (GUI) in order to allow a user of the device to control the camera. A user of a camera-enabled device may want to create a video that includes certain types of cinematic shots that the user may have seen in an existing video. However, the user may not know what type of cinematic shots were used in the existing video. Moreover, the GUI of the camera application may not provide sufficient guidance on capturing certain types of cinematic shots. For example, the GUI of the camera application may not instruct the user on how to move the camera while the camera is capturing video.

The present disclosure provides methods, systems, and/or devices for generating a target camera trajectory for a new video based on an estimated camera trajectory associated with an existing video. A user provides an existing video. The device determines an estimated camera trajectory of a camera that was used to capture the existing video. The device determines a target camera trajectory for the new video based on the estimated camera trajectory that was used to capture the existing video.

The estimated camera trajectory may indicate a type of cinematic shot that was used to capture the existing video. Moving the camera along the target camera trajectory allows the user to capture the new video using the same type of cinematic shot that was used to capture the existing video. The estimated camera trajectory indicates how a camera operator may have moved a camera while the camera was capturing the existing video. The target camera trajectory indicates how a camera operator ought to move the camera in order to capture the new video. For example, if the estimated camera trajectory indicates that the camera operator encircled a subject while capturing the existing video then the target camera trajectory for the new video includes a circular path. As another example, if the estimated camera trajectory indicates that the camera operator moved towards a subject in a straight line while capturing the existing video then the target camera trajectory for the new video includes a linear path the extends towards a subject that is to be filmed.

The device may perform a frame-by-frame analysis of the existing video and indicate which type of cinematic shot was utilized to capture each frame in the existing video. During the creation of the new video, the device can utilize the same types of cinematic shots that were utilized in capturing the existing video. The device can generate the target camera trajectory by modifying an estimated camera trajectory from the existing video based on an environment in which the new video is to be captured. The device can modify an estimated camera trajectory from the existing video based on differences between respective environments of the existing video and the new video. For example, if the environment for the new video includes physical obstacles that were not present in the environment of the existing video, the device can modify an estimated camera trajectory such that the target camera trajectory avoids the physical obstacles. As another example, if the environment for the new video has different dimensions than the environment for the existing video, the device can modify the estimated camera trajectory so that the target camera trajectory compensates for the dimensional differences between the two environments.

The device can display a virtual indicator to indicate the target camera trajectory. The virtual indicator may indicate a direction and/or a speed for moving the device in order to capture the new video using the same type of cinematic shot as the existing video. The device can indicate the target camera trajectory by displaying a set of one or more XR objects. For example, the device can display an illuminated path along the target camera trajectory. In this example, the user can walk along the illuminated path while capturing the new video in order to capture the new video using the same type of cinematic shot as the existing video. As another example, the device can display a virtual character walking along the target camera trajectory and the user can follow the virtual character while capturing the new video in order to capture the new video using a type of cinematic shot associated with the target camera trajectory.

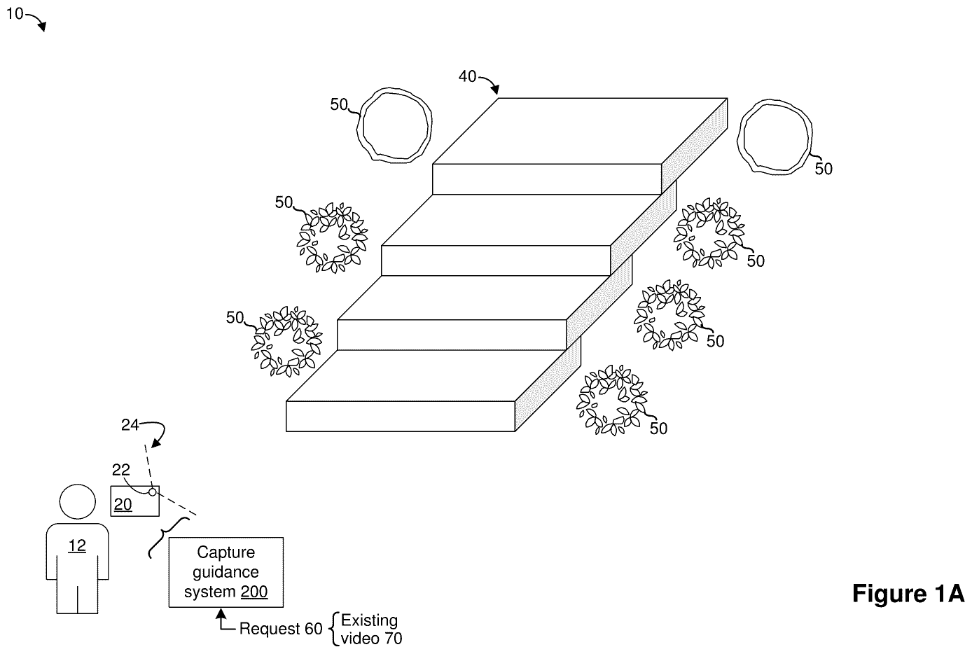

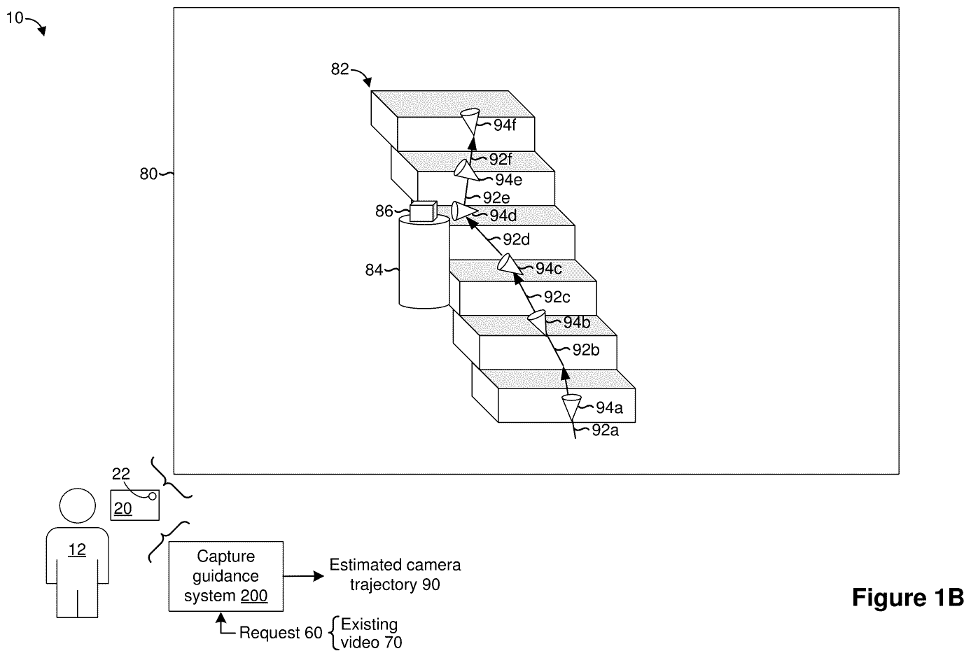

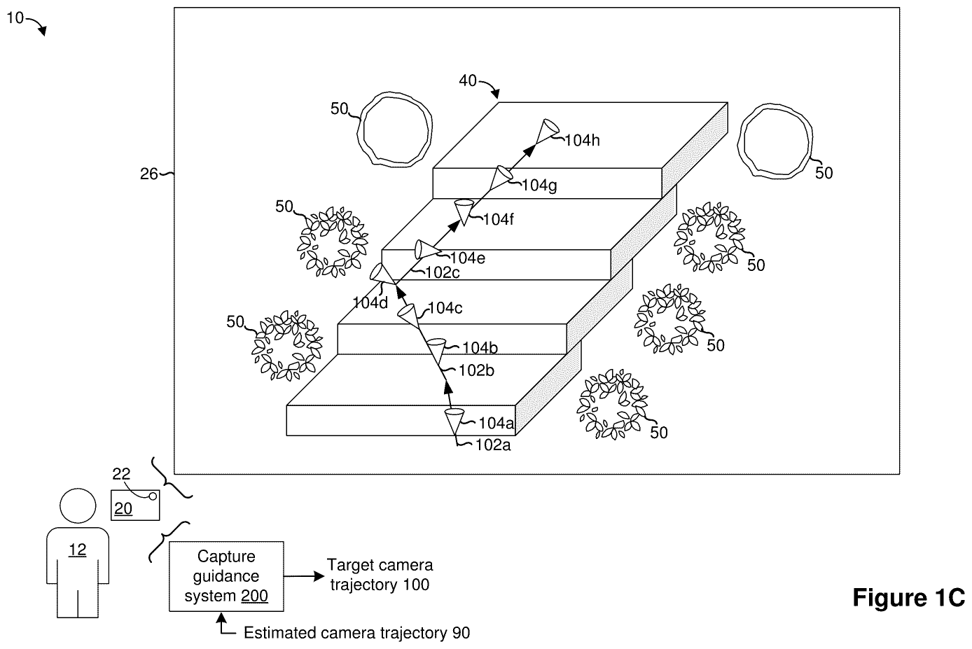

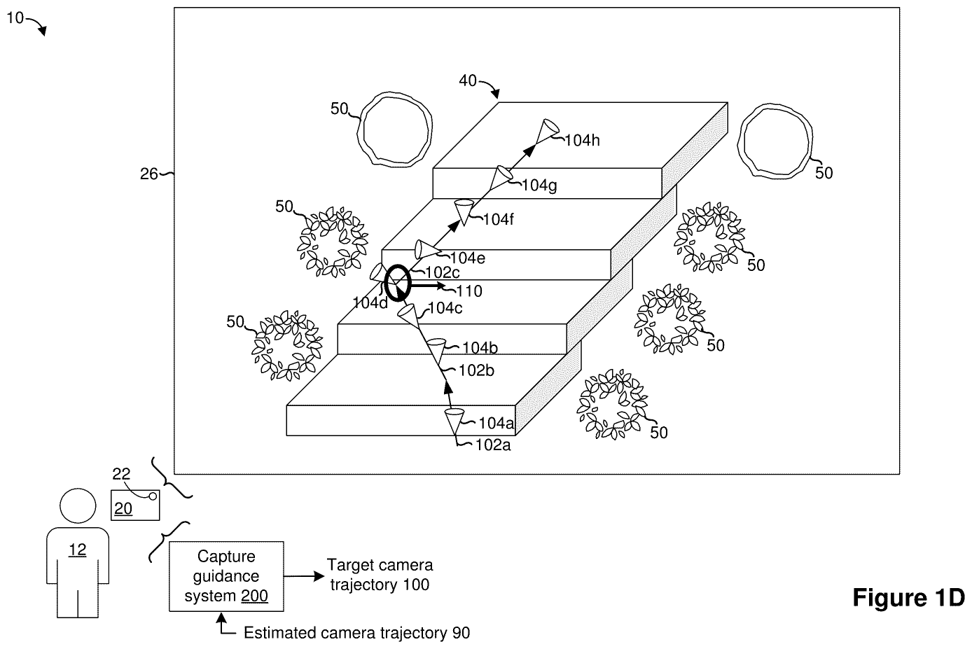

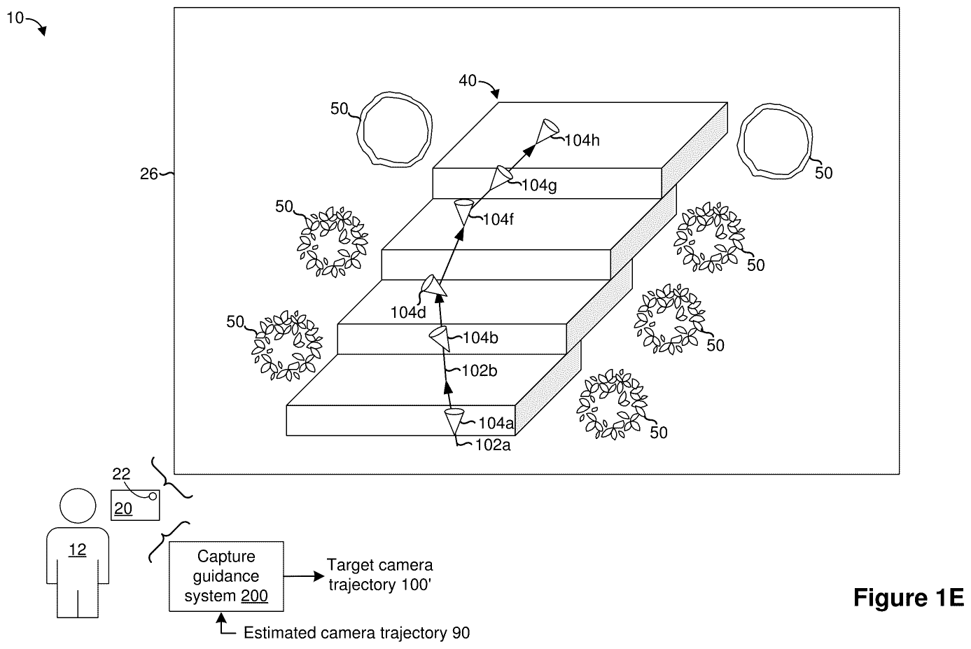

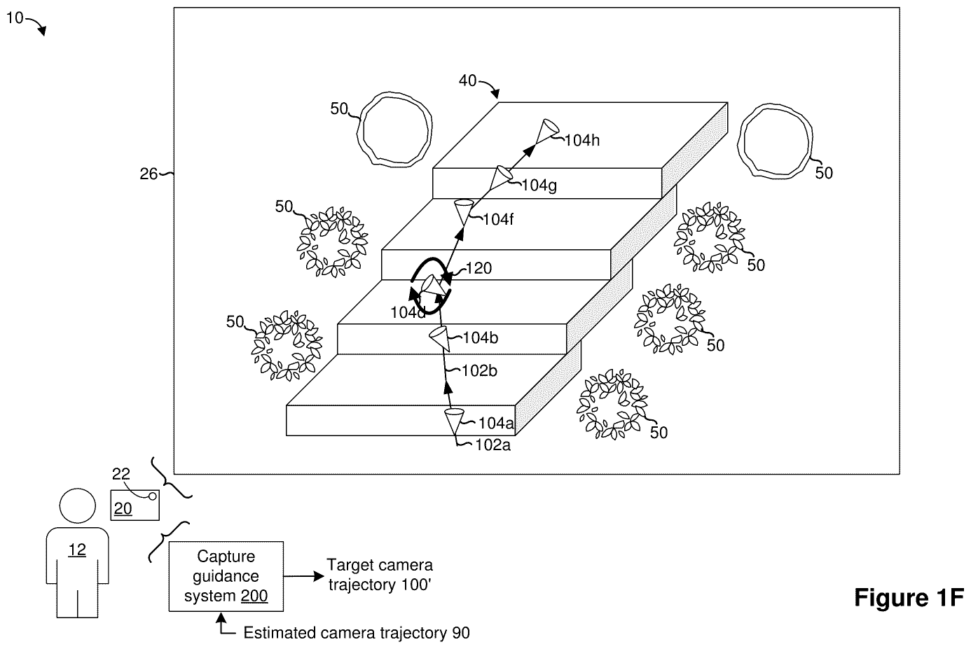

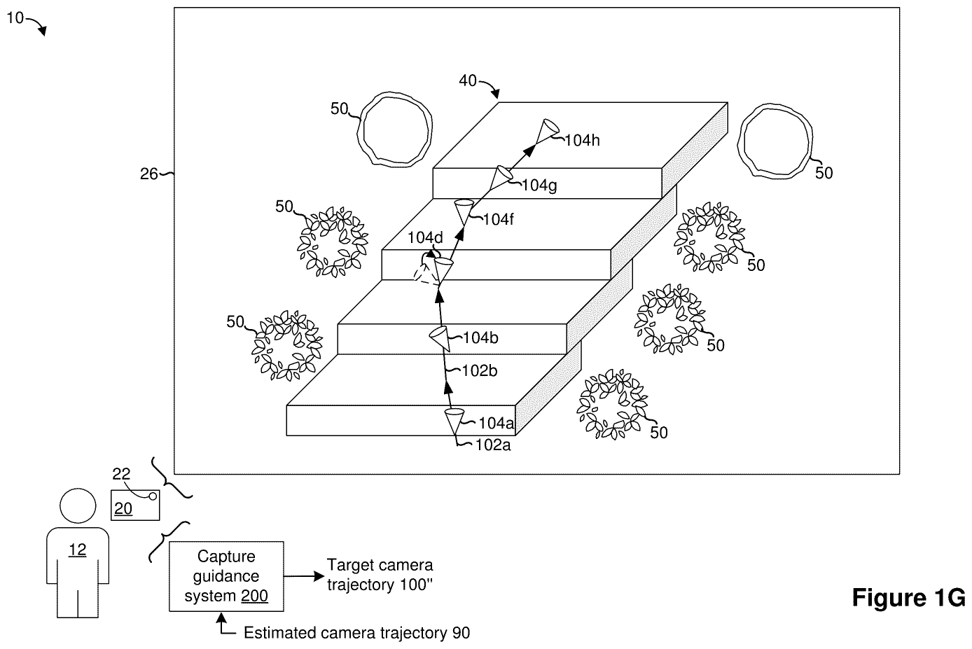

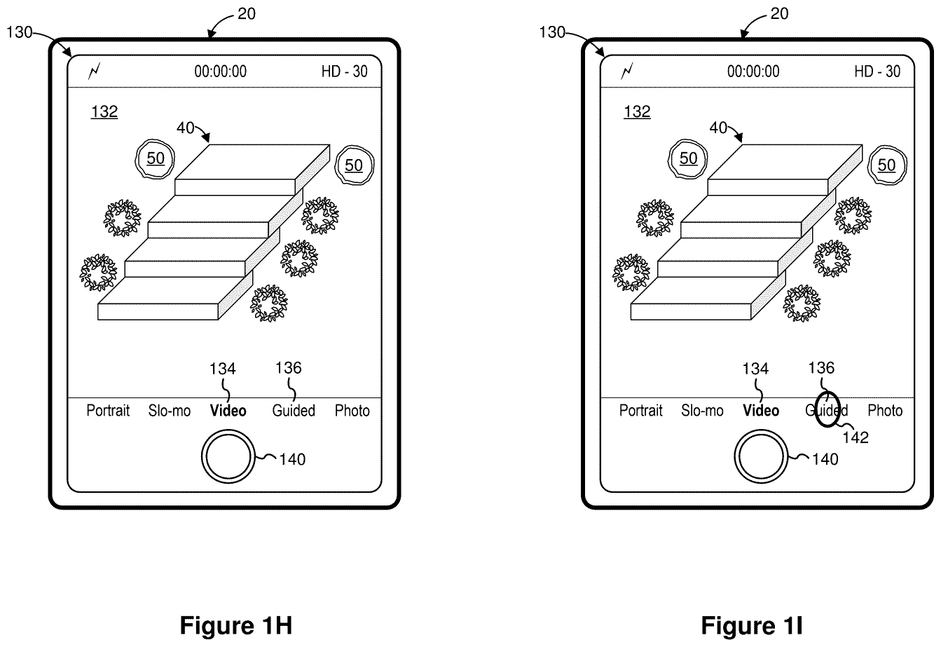

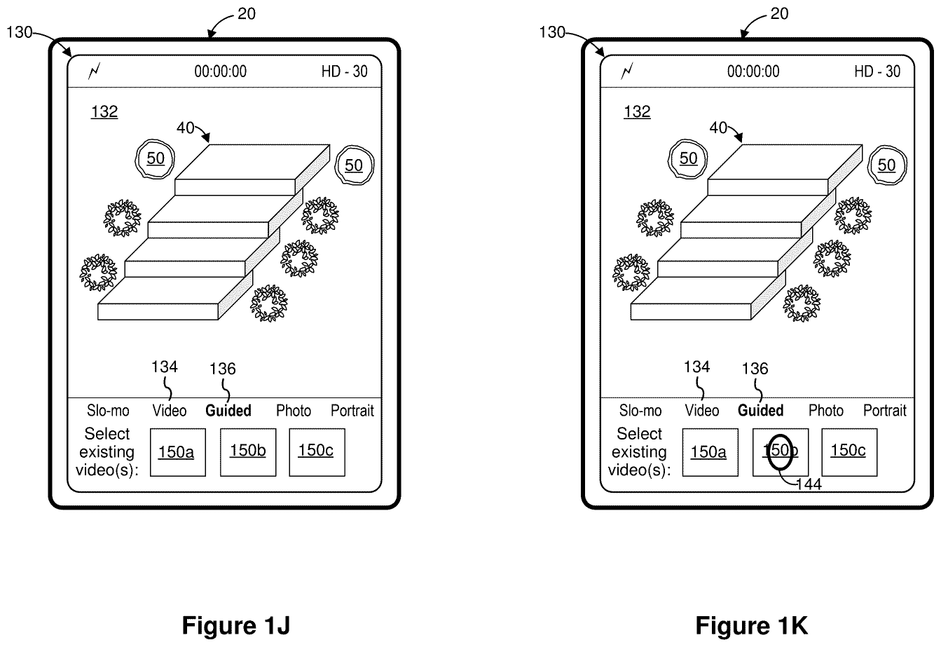

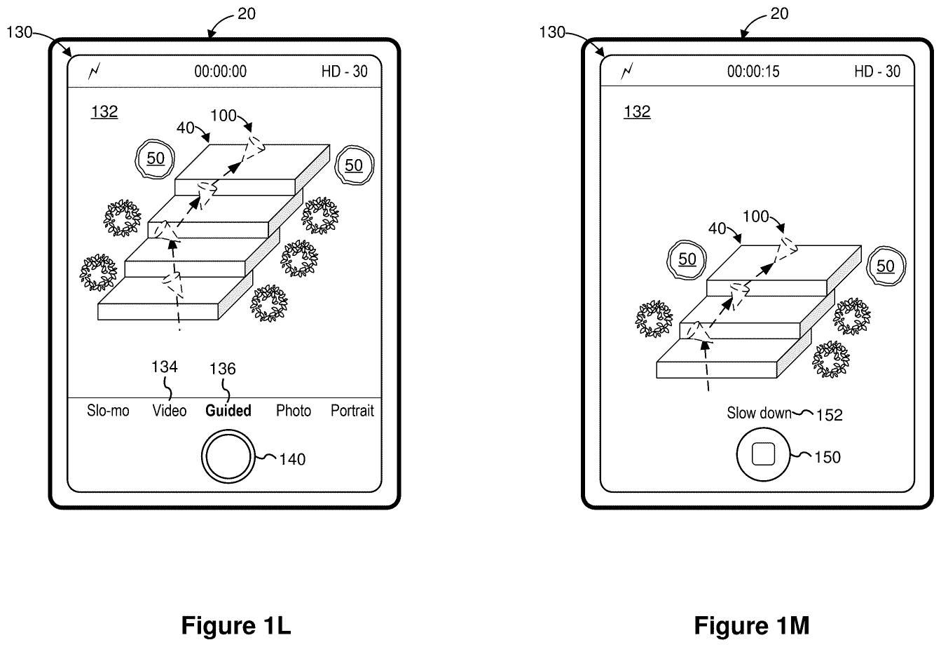

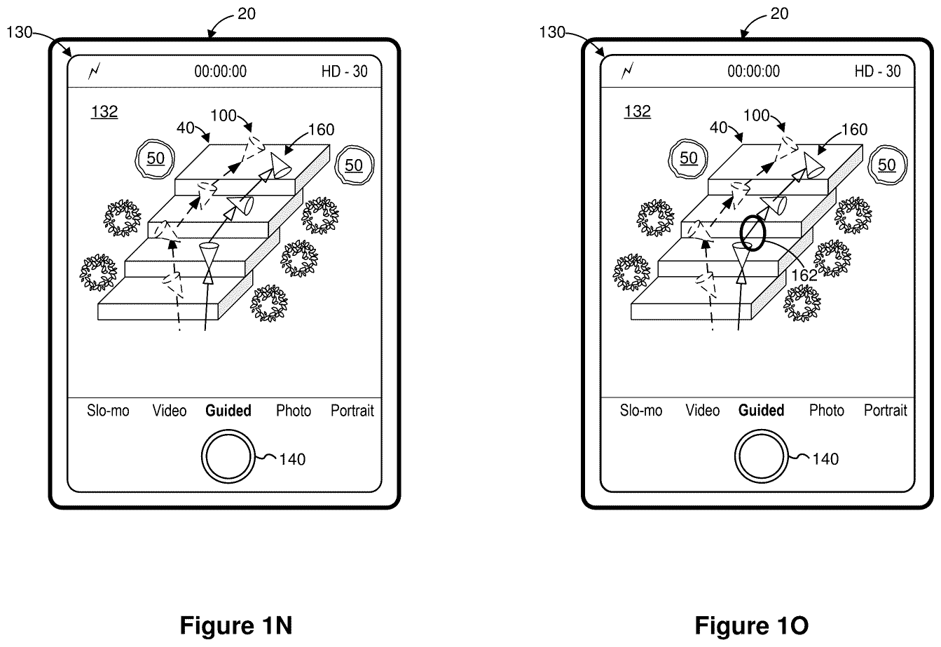

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity), stairs 40 and various plants 50. In some implementations, the device 20 includes a capture guidance system 200 that guides the user 12 in capturing images and/or videos of the physical environment 10.

In some implementations, the device 20 includes a handheld computing device that can be held by the user 12. For example, in some implementations, the device 20 includes a smartphone, a tablet, a media player, a laptop, or the like. In some implementations, the device 20 includes a wearable computing device that can be worn by the user 12. For example, in some implementations, the device 20 includes a head-mountable device (HMD) or an electronic watch.

In various implementations, the device 20 includes a display and a camera application for controlling a camera 22. In some implementations, the device 20 includes the camera 22 (e.g., the camera 22 is integrated into the device 20). Alternatively, in some implementations, the camera 22 is separate from the device 20 and the device 20 controls the camera 22 via a control channel (e.g., a wireless control channel, for example, via short-range wireless communication). The camera 22 is associated with a field of view 24. When the camera 22 captures images and/or videos, objects that are in the field of view 24 of the camera are depicted in the images and/or videos captured by the camera 22. In the example of FIG. 1A, the stairs 40 and the plants 50 are in the field of view 24 of the camera 22.

In the example of FIG. 1A, the device 20 receives a request 60 to capture a video of the physical environment 10. The user 12 may want to capture the video of the physical environment 10 using a cinematic shot that was used in capturing an existing video 70. As such, the user 12 can provide the existing video 70 as a part of the request 60. The existing video 70 may include a video that the user 12 previously captured. Alternatively, the existing video 70 may have been captured by someone else. For example, the existing video 70 may be a clip from a movie or a TV show.

Referring to FIG. 1B, the device 20 and/or the capture guidance system 200 generates a reconstructed scene 80 that represents an environment where the existing video 70 was captured. As illustrated in FIG. 1B, the reconstructed scene 80 includes stairs 82, a pedestal 84 and a statue 86 placed on top of the pedestal 84. In some implementations, the device 20 generates the reconstructed scene 80 by performing instance segmentation and/or semantic segmentation on the existing video 70. In some implementations, the device 20 utilizes a NeRF model to generate the reconstructed scene 80. For example, the device 20 utilizes a zero/few-shor NeRF such as a pixelNeRF to generate the reconstructed scene 80.

In various implementations, the device 20 determines an estimated camera trajectory 90 of a camera that captured the existing video 70. The estimated camera trajectory 90 indicates a series of poses of the camera while the camera captured the existing video 70. In the example of FIG. 1B, the estimated camera trajectory 90 includes arrows that indicate directional movements of the camera (e.g., positions of the camera) and cones that indicate directions in which the camera was pointing (e.g., orientations of the camera). As illustrated by a first arrow 92a, a camera operator (e.g., the user 12) started by going up the stairs 82 while staying towards the center of the stairs 82. As illustrated by a first cone 94a, the camera was initially pointing straight towards the top of the stairs 82. As illustrated by a second arrow 92b, a third arrow 92c and a fourth arrow 92d, the camera operator moved the camera leftwards towards the statue 86 while advancing up the stairs 82. As illustrated by a second cone 94b, a third cone 94c and a fourth cone 94c, the camera operator rotated the camera towards the statue 86 in order to get a close-up shot of the statue 94d. As illustrated by a fifth arrow 92e and a sixth arrow 92f, the camera operator moved the camera back towards a center axis of the stairs 82 while climbing towards the top of the stairs after capturing a close-up shot of the statue 86. As illustrated by a fifth cone 94e and a sixth cone 94e, the camera operator rotated the camera back towards the center axis of the stairs while climbing towards the top of the stairs 82 after capturing the close-up shot of the statue 86.

In various implementations, the device 20 determines the estimated camera trajectory 90 by performing a frame-by-frame analysis of the existing video 70. In some implementations, the device 20 determines the estimated camera trajectory 90 based on changes in respective points of view of the camera associated with each of the frames in the existing video 70. In some implementations, the device 20 utilizes a neural radiance field (NeRF) model to determine the estimated camera trajectory 90. For example, for each frame in the existing video 70, the device 20 utilizes a NeRF model based on an input frame from a previous time frame to estimate a pose (e.g., a position and/or an orientation) of the camera. In some implementations, the device 20 utilizes a first model (e.g., a first NeRF, for example, a zero/few-shor NeRF such as a pixelNeRF) to generate the reconstructed scene 80 and a second model (e.g., a second NeRF, for example, an iNeRF) to extract the estimated camera trajectory 90 of a camera that captured the existing video 70.

Referring to FIG. 1C, the device 20 (e.g., the capture guidance system 200) generates a target camera trajectory 100 based on the estimated camera trajectory 90 that was utilized to capture the existing video 70. In various implementations, the target camera trajectory 100 is similar to the estimated camera trajectory 90. In some implementations, the device 20 generates the target camera trajectory 100 by modifying the estimated camera trajectory 90 based on differences between the reconstructed scene 80 and the physical environment 10. For example, the target camera trajectory 100 accounts for dimensional differences between the reconstructed scene 80 and the physical environment 10. As another example, the target camera trajectory 100 accounts for obstructions in the physical environment 10 that may not be present in the reconstructed scene 80. In various implementations, the target camera trajectory 100 guides the user 12 to capture a video of the physical environment 10 using the same cinematic shot that was used in the existing video 70.

In the example of FIG. 1C, the device 20 indicates the target camera trajectory 100 by displaying a series of arrows and cones on a display 26. The arrows indicate target positions for the camera 22 and the cones indicate target orientations for the camera 22. For example, a first arrow 102a guides the user 12 towards a central axis of the stairs 40 similar to first arrow 92a in FIG. 1B indicating that the camera operator stayed towards the center of the stairs 82 at the beginning of the existing video 70. A first cone 104a guides the user 12 to point the camera 22 roughly straight towards the top of the stairs 40 similar to the first cone 94a in FIG. 1B indicating that the camera operator pointed the camera towards the center axis of the stairs 82. A second arrow 102b guides the user 12 towards the middle plant 50 on the left side of the stairs 40 similar to the arrows 92b, 92c and 92d indicating that the camera operator moved the camera leftwards towards the statue 86 in FIG. 1B. A second cone 104b, a third cone 104c and a fourth cone 104d guide the user 12 to gradually point the camera 22 towards the middle plant 50 in order to get a close-up shot of the middle plant 50 similar to how the camera operator got the close-up shot of the statue 86 in FIG. 1B. After capturing the close-up shot of the middle plant 50, a third arrow 102c guides the user 12 back towards the center axis of the stairs 40 similar to how the camera operator moved towards the center axis of the stairs 82 after capturing a close-up shot of the statue 86 in FIG. 1B. A fifth cone 104e, a sixth cone 104f, a seventh cone 104g and an eighth cone 104h guide the user 12 to gradually rotate the camera 22 away from the middle plant 50 and towards the center axis of the stairs 40 similar to how the camera operator gradually rotated the camera towards the center axis of the stairs 82 after capturing the close-up shot of the statue 86 shown in FIG. 1B. As can be seen in FIGS. 1B and 1C, the target camera trajectory 100 guides the user 12 in capturing a new video of the physical environment 10 using a cinematic shot that is the same as or very similar to the cinematic shot that was used to capture the existing video.

FIGS. 1D-1G illustrate how the user 12 can make changes to the target camera trajectory 100 generated by the device 20. In the example of FIG. 1D, the device 20 detects a drag input 110 that corresponds to the user 12 dragging the fourth cone 104d rightwards towards the center axis of the stairs 40. Referring to FIG. 1E, in response to detecting the drag input 110 in FIG. 1D, the device 20 generates a modified target camera trajectory 100′ in which the fourth cone 104d is closer to the center axis of the stairs 40 than the middle plant 50. As such, if the user 12 follows the modified target camera trajectory 100′ the resulting video includes a focused shot of the middle plant 50 but not a close-up of the middle plant 50.

In FIG. 1F, the device 20 detects a rotate input 120 directed to the fourth cone 104d. The rotate input 120 corresponds to a user request to rotate a direction in which the camera is pointing when the camera is at the location corresponding to the fourth cone 104d. Specifically, the rotate input 120 corresponds to a request to rotate the camera 22 rightwards so that the camera 22 is pointing more towards the center axis of the stairs 40. As shown in FIG. 1G, in response to detecting the rotate input 120 in FIG. 1F, the device 20 generates yet another modified target camera trajectory 100″ in which the fourth cone 104d is pointing towards the center axis of the stairs 40 and not the middle plant 50. As such, following the modified target camera trajectory 100″ would result in a new video that does not include a close-up shot or even a focused shot of the middle plant 50.

FIG. 1H illustrates a camera graphical user interface (GUI) 130 that guides the user 12 in capturing a new video of an environment using a cinematic shot that is the same as or similar to a cinematic shot that was used to capture a previously-captured video (e.g., the existing video 70 shown in FIGS. 1A-1B). In various implementations, the camera GUI 130 includes an image preview 132 that shows objects that are in the field of view 24 of the camera 22 shown in FIG. 1A. The camera GUI 130 includes a video option 134 for capturing a video. The camera GUI 130 includes a guided option 136 for displaying a visual guide that guides the user 12 in capturing a new video using camera poses that were used to capture a previously-captured video. The camera GUI 130 includes a capture button 140 for initiating video capture.

Referring to FIG. 1I, the device 20 detects a user input 142 (e.g., a tap gesture) directed to the guided option 136. Referring to FIG. 1J, in response to detecting the user input 142 shown in FIG. 1I, the device 20 displays a set of existing videos (e.g., a first existing video 150a, a second existing video 150b and a third existing video 150c). The camera GUI 130 prompts the user 12 to select one of the existing videos to model the new video after. The existing videos 150a, 150b and 150c may be stored in association with a video gallery. As such, the existing video may have been captured by the device 20 at a previous time. Alternatively, the camera GUI 130 provides the user 12 an option to select an existing video from a video library that stores videos captured by other devices. For example, the camera GUI 130 can provide the user 12 an option to select a clip from a movie or a TV show thereby allowing the user 12 to capture a new video using a cinematic shot that a director used in the movie or the TV show.

Referring to FIG. 1K, the device 20 detects a user input 144 (e.g., another tap gesture) directed to the second existing video 150b. The user input 144 corresponds to a request to display a visual guide that allows the user 12 to capture a new video of the environment using a cinematic shot that was used to capture the second existing video 150b. The device 20 performs a frame-by-frame analysis of the second existing video 150b to determine an estimated camera trajectory of a camera while the camera was capturing the second existing video 150b. The device 20 generates the target camera trajectory 100 based on the estimated camera trajectory used in the second existing video 150b. The device 20 can generate the target camera trajectory 100 by modifying the estimated camera trajectory based on differences between an environment where the second existing video 150b was captured and another environment where the new video is to be captured (e.g., based on differences in dimensions and/or placement of objects).

Referring to FIG. 1L, the device 20 displays a visual indicator of the target camera trajectory 100 on the display. In the example of FIG. 1L, the visual indicator of the target camera trajectory 100 includes a set of augmented reality (AR) objects that are overlaid on top of a pass-through representation of the physical environment 10. As such, the visual indicator of the target camera trajectory 100 does not occlude a view of the physical environment 10.

Referring to FIG. 1M, the device 20 shows the camera GUI 130 when the user 12 has started recording the new video. The capture button 140 has been replaced by a stop button 150 to stop the recording. As the user 12 moves the device 20 along a path indicated by the target camera trajectory 100, the device 20 displays speed guidance 152 to indicate how fast the user 12 ought to move the device 20 in order to capture the new video using the same type of cinematic shot as the second existing video 150b. In the example of FIG. 1M, the speed guidance 152 is to slow down, for example, because the user 12 is moving the device 20 faster than a speed threshold associated with the target camera trajectory 100.

Referring to FIG. 1N, in some implementations, the device 20 generates multiple potential target camera trajectories for the user 12 to select from. In the example of FIG. 1N, the device 20 displays a second target camera trajectory 160 in addition to displaying the target camera trajectory 100. In some implementations, the existing video utilizes multiple cinematic shots that may be suitable for capturing a new video of the physical environment 10. As such, the device 20 allows the user 12 to select one of the many cinematic shots that may be suitable for filming the physical environment 10. As shown in FIG. 1O, the device 20 detects a user input 162 selecting the second target camera trajectory 160. After detecting the selection of the second target camera trajectory 160, the device 20 forgoes displaying the target camera trajectory 100 while maintaining display of the second target camera trajectory 160 on top of the image preview 132.

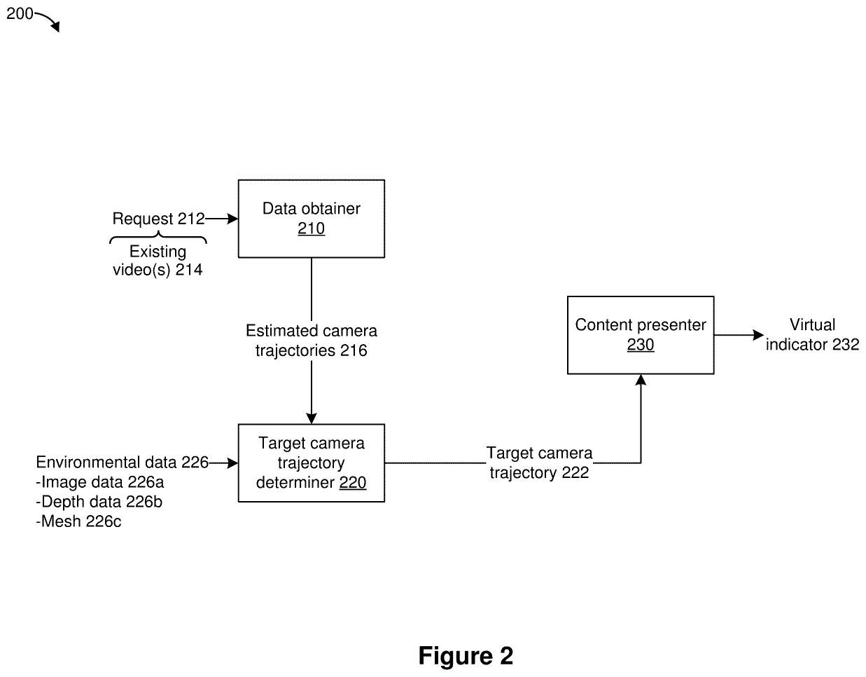

FIG. 2 is a block diagram of the capture guidance system 200 (“system 200”, hereinafter for the sake of brevity) in accordance with some implementations. In some implementations, the system 200 includes a data obtainer 210, a target camera trajectory determiner 220 and a content presenter 230. In various implementations, the system 200 resides at (e.g., is implemented by) the device 20 shown in FIGS. 1A-1O. Alternatively, in some implementations, the system 200 resides at a remote device (e.g., at a server or a cloud computing platform).

In various implementations, the data obtainer 210 obtains a request 212 to capture a new video of an environment (e.g., the physical environment 10 shown in FIG. 1A). In some implementations, the data obtainer 210 receives the request 212 via a GUI of a camera application (e.g., the camera GUI 130 shown in FIGS. 1H-1O). In some implementations, the request 212 is associated with a set of one or more existing videos 214 (“existing video 214”, hereinafter for the sake of brevity). In some implementations, the user specifies the existing video 214 (e.g., as shown in FIG. 1K, the user 12 selects the second existing video 150b). Alternatively, in some implementations, the system 200 automatically selects an existing video based on a similarity between an environment depicted in the existing video and the physical environment that is being captured. For example, if the physical environment being filmed includes animals, the system 200 recommends using a cinematic shot from an existing video that depicts animals. As another example, if the physical environment being filmed includes a natural landmark, the system 200 recommends using a cinematic shot from an existing video that depicts a natural landmark (e.g., the same natural landmark that is currently being filmed or a similar natural landmark).

In various implementations, the data obtainer 210 determines a set of one or more estimated camera trajectories 216 (“estimated camera trajectory 216”, hereinafter for the sake of brevity) of a camera that captured the existing video 214. For example, the data obtainer 210 determines the estimated camera trajectory 90 shown in FIG. 1B. In some implementations, the data obtainer 210 determines the estimated camera trajectory 216 by estimating a translation and/or a rotation of a camera relative to a 3D model of the captured environment. In such implementations, the data obtainer 210 can reconstruct the 3D model of the captured environment based on a semantic analysis of the existing video 214. Furthermore, in such implementations, the data obtainer 210 can estimate the translation and/or the rotation of the camera relative to the 3D model based on changes in respective positions and/or respective orientations of objects in sequential frames of the existing video 214. For example, if sequential frames of the existing video 214 show that an object is getting bigger, the estimated camera trajectory 216 shows the camera moving towards the object in a straight line.

In some implementations, the data obtainer 210 utilizes a set of one or more NeRF models to determine the estimated camera trajectory 216. In some implementations, the data obtainer 210 utilizes a first NeRF model to reconstruct the 3D model of the environment depicted in the existing video 214. For example, the data obtainer 210 uses a zero/few-shor NeRF such as pixelNeRF to reconstruct the 3D model of the environment depicted in the existing video 214. In some implementations, the data obtainer utilizes a second NeRF model and the 3D model of the environment to extract the estimated camera trajectory 216 from the existing video 214. For example, the data obtainer 210 uses the reconstructed 3D model of the environment depicted in the existing video 214 and an iNeRF to extract the estimated camera trajectory 216 from the existing video 214.

In various implementations, the target camera trajectory determiner 220 determines a target camera trajectory 222 based on the estimated camera trajectory 216 and environmental data 226 characterizing the environment in which the new video is to be captured (e.g., the target camera trajectory 100 shown in FIG. 1C). The environmental data 226 may include image data 226a (e.g., a set of one or more images of the environment), depth data 226b and/or a mesh 226c. In some implementations, the environmental data 226 indicates a 3D model of the environment. For example, the target camera trajectory determiner 220 may utilize the environmental data 226 to construct the 3D model of the environment.

In various implementations, the target camera trajectory determiner 220 utilizes a generative model to generate the target camera trajectory 222. In some implementations, the generative model accepts the estimated camera trajectory 216 and the environmental data 226 as inputs, and outputs the target camera trajectory 222 as an output. In some implementations, the generative model is trained using existing videos with expert-provided camera trajectories for each existing video.

In some implementations, the target camera trajectory determiner 220 determines the target camera trajectory 222 by modifying the estimated camera trajectory 216. In some implementations, the target camera trajectory determiner 220 generates the target camera trajectory 222 by adjusting the estimated camera trajectory 216 based on a difference in respective dimensions of the environment depicted in the existing video 214 and the environment in which the new video is to be captured. For example, the target camera trajectory 222 is an upscaled version of the estimated camera trajectory 216 when the environment where the new video is being captured is larger than the environment depicted in the existing video 214, and the target camera trajectory 222 is a downscaled version of the estimated camera trajectory 216 when the environment of the new video is smaller than the environment of the existing video 214. In some implementations, the target camera trajectory determiner 220 modifies the estimated camera trajectory 216 based on respective locations of objects in the environment of the new video in order to avoid colliding with obstructions. For example, if following the estimated camera trajectory 216 in the current environment would result in a collision of the camera with a physical object, the target camera trajectory determiner 220 modifies the estimated camera trajectory 216 so that the target camera trajectory 222 avoids the collision of the camera with the physical object.

In some implementations, the estimated camera trajectory 216 includes multiple estimated camera trajectories and the target camera trajectory determiner 220 determines the target camera trajectory 222 by selecting one of the estimated camera trajectories. The target camera trajectory determiner 220 can determine suitability scores for each of the estimated camera trajectories and select the estimated camera trajectory with the greatest suitability score as the target camera trajectory 222. The suitability score for a particular estimated camera trajectory may indicate a suitability of that particular estimated camera trajectory for the current environment. The suitability score may be a function of dimensions of the current environment. For example, an estimated camera trajectory with camera movements that requires a relatively large environment may be assigned a relatively low suitability score if the current environment is not sufficiently large to accommodate the camera movements in the estimated camera trajectory. The suitability score may be a function of physical objects in the current environment. For example, an estimated camera trajectory that intersects with physical objects in the current environment may be assigned a relatively low suitability score whereas an estimated camera trajectory that does not intersect with physical objects in the current environment may be assigned a relatively high suitability score.

In some implementations, the target camera trajectory determiner 220 prompts the user to select the target camera trajectory 222 from a set of candidate camera trajectories. The target camera trajectory determiner 220 detects a user input selecting one of the candidate camera trajectories and sets the selected candidate camera trajectory as the target camera trajectory 222. For example, as shown in FIG. 1O, the device 20 detects the user input 162 selecting the second target camera trajectory 160.

In various implementations, the content presenter 230 displays a virtual indicator 232 of the target camera trajectory 222. For example, as shown in FIG. 1C, the device 20 displays various arrows to indicate target camera movements and various cones to indicate target camera orientations. In some implementations, the virtual indicator 232 is overlaid on top of a representation of the physical environment. For example, as shown in FIG. 1L, the device 20 overlays the target camera trajectory 100 on top of the image preview 132. In various implementations, the content presenter 230 allows the user to change the target camera trajectory 222 by providing a user input. For example, as shown in FIG. 1D, the user can manipulate the target camera trajectory 222 by dragging or rotating various portions of the target camera trajectory 222.

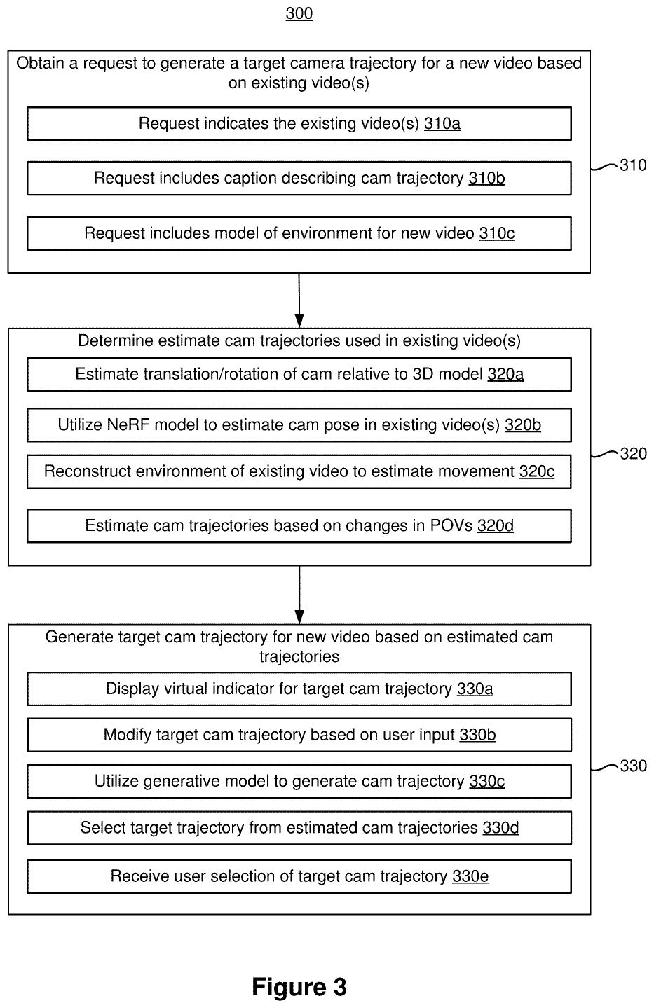

FIG. 3 is a flowchart representation of a method 300 for generating a target camera trajectory for a new video. In various implementations, the method 300 is performed by a device including a display, an image sensor, a non-transitory memory and one or more processors coupled with the display, the image sensor and the non-transitory memory (e.g., the device 20 shown in FIGS. 1A-1O and/or the system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes obtaining a request to generate a target camera trajectory for a new video based on an existing video. For example, as shown in FIG. 1A, the device 20 and/or the system 200 receive the request 60 to capture a new video of the physical environment 10 using a cinematic shot that is similar to a cinematic shot that was used to capture the existing video 70. In some implementations, the device receives the request via a user interface of a camera application (e.g., the camera GUI 130 shown in FIGS. 1H-1O).

In some implementations, the new video is to be captured in a first environment (e.g., a first physical environment or a first simulated environment) and the existing video was captured in a second environment that is different from the first environment (e.g., a second physical environment that is different from the first physical environment or a second simulated environment that is different from the first simulated environment). Alternatively, in some implementations, the new video is to be captured in the same environment as the existing video. In some implementations, the new video is to be captured in a physical environment and the existing video was captured in a simulated environment (e.g., a simulated version of the physical environment or an entirely different simulated environment). Alternatively, in some implementations, the new video is to be captured in a simulated environment and the existing video was captured in a physical environment.

As represented by block 310a, in some implementations, the request includes the existing video or a link to the existing video. In some implementations, the user captured the existing video at a previous time. As such, the existing video may be stored in association with a photos application of the device and the user can select the existing video from the photos application upon providing the request (e.g., as shown in FIGS. 1J-1K). Alternatively, another person may have captured the existing video at a previous time. For example, the existing video may be a portion of a movie or a TV show. In this example, the user may specify the existing video by selecting the existing video from a library of movie and TV show clips, or by specifying the name of the movie and describing the scene from the movie (e.g., by typing “Indiana rope bridge scene” into a search bar displayed by the camera GUI).

As represented by block 310b, in some implementations, the request includes a caption for the existing video that describes an estimated camera trajectory of a camera that captured the existing video. For example, referring to FIG. 1B, the user 12 may provide a caption for the existing video 70 that reads “going up the stairs”. Alternatively, in some implementations, the device automatically generates the caption for the existing video. In some implementations, the device utilizes the caption to estimate a trajectory of a camera that captured the existing video. For example, the device may perform a semantic analysis on “going up the stairs” and the semantic analysis may indicate that the camera was moved along a linear path that started at a bottom of a staircase and finished at a top of the staircase. In some implementations, the device utilizes the caption to determine whether a cinematic shot used to capture the existing video is suitable for capturing a new video of the current environment. For example, the device may perform entity recognition on “going up the stairs” to determine that the existing video depicts a set of stairs, and that a cinematic shot used to capture the existing video is suitable for capturing a new video of the current environment because the current environment includes stairs.

As represented by block 310c, in some implementations, the request includes the model of the environment in which the new video is to be captured. As shown in FIG. 2, in some implementations, the system 200 captures the environmental data 226 characterizing the environment in which the new video is to be captured, and the device utilizes the environmental data 226 to generate the model of the environment. In some implementations, the model includes a 3D model. In some implementations, the model includes a mesh of the physical environment and/or a texture map of the physical environment. In some implementations, the model includes a NeRF model of the physical environment (e.g., a zero/few-shor NeRF such as pixelNeRF or an iNeRF).

In some implementations, the request includes a second existing video that depicts the environment in which the new video is to be captured, and the device generates the model of the environment in which the new video is to be captured based on the second existing video. For example, the device may prompt the user to capture a video of the physical environment prior to generating a target camera trajectory. The device can utilize the video of the physical environment to model the physical environment and generate the target camera trajectory based on the model of the physical environment.

As represented by block 320, in some implementations, the method 300 includes determining a set of one or more estimated camera trajectories that were utilized to capture the existing video based on an image analysis of the existing video. For example, as shown in FIG. 1B, the device 20 determines the estimated camera trajectory 90 of a camera that captured the existing video 70. In some implementations, the device determines multiple estimated camera trajectories for a single existing video and the device associates a confidence score with each of the estimated camera trajectories. In such implementations, the confidence score for a particular estimated camera trajectory indicates a degree of confidence in that particular estimated camera trajectory. In such implementations, the device can select the estimated camera trajectory with the greatest confidence score as the most likely path of the camera that captured the existing video.

In some implementations, the method 300 includes determining respective estimated camera trajectories for multiple existing videos. For example, referring to FIG. 1K, the user 12 may select two of the existing videos. In this example, the device 20 determines an estimated camera trajectory for each of the selected videos. In some implementations, the method 300 includes selecting one of the estimated camera trajectories and generating the target camera trajectory based on the selected one of the estimated camera trajectories. For example, the device may select the estimated camera trajectory that is most suitable for the current physical environment and modify the selected estimated camera trajectory in order to generate the target camera trajectory.

As represented by block 320a, in some implementations, determining the set of one or more estimated camera trajectories includes, for each frame in the existing video, determining a translation and a rotation of a camera relative to a three-dimensional (3D) model that corresponds to an environment where the existing video was captured. In various implementations, the device estimates a camera pose (e.g., a position and/or an orientation) for each frame in the existing video and determines the estimated camera trajectory for the existing video based on changes in the camera pose across various frames of the existing video.

As represented by block 320b, in some implementations, determining the set of one or more estimated camera trajectories includes, for each time frame in the existing video, utilizing a neural radiance field (NeRF) model based on an input frame from a previous time frame to estimate a pose of the camera. For example, the NeRF model accepts a first frame captured at a first time as an input to estimate a pose of the camera in a second frame that was captured at a second time that occurs after the first time.

As represented by block 320c, in some implementations, determining the set of one or more estimated camera trajectories includes reconstructing at least a portion of a first three-dimensional (3D) environment in which the existing video was captured, and utilizing a reconstruction of the first 3D environment to extract the set of one or more estimated camera trajectories of a camera that captured the existing video. For example, the device utilizes a first model (e.g., a first NeRF, for example, a zero/few-shor NeRF such as pixelNeRF) to reconstruct the environment depicted in the existing video and a second model (e.g., a second NeRF, for example, an iNeRF) to extract the estimated camera trajectory of a camera that captured the existing video.

As represented by block 320d, in some implementations, determining the set of one or more estimated camera trajectories includes determining the set of one or more estimated camera trajectories based on changes in points of view of the existing video. In some implementations, the device tracks changes in the points of view by tracking display positions of one or more objects depicted in the existing video.

As represented by block 330, in various implementations, the method 300 includes generating the target camera trajectory for the new video based on the set of one or more estimated camera trajectories that were utilized to capture the existing video and a model of an environment in which the new video is to be captured. For example, as shown in FIG. 1C, the device 20 generates the target camera trajectory 100 based on the estimated camera trajectory 90 shown in FIG. 1B and a model of the physical environment 10. In various implementations, generating the target camera trajectory tends to reduce the need to capture multiple videos in order to capture a desired cinematic shot of the physical environment. Since capturing videos drains a battery of the device, reducing a number of video captures extends a battery of the device thereby enhancing operability of the device.

As represented by block 330a, in some implementations, the method 300 includes displaying a virtual indicator of the target camera trajectory. For example, as shown in FIG. 1C, the device 20 overlays the target camera trajectory 100 using a set of arrows and cones. In some implementations, the method 300 includes overlaying the virtual indicator on a pass-through representation of the environment in which the new video is to be captured. For example, as shown in FIG. 1L, the device 20 overlays the target camera trajectory 100 on top of the camera GUI 130. Overlaying the virtual indicator of the target camera trajectory allows a camera operator operating the camera to simultaneously view the physical environment being captured and the target camera trajectory. Furthermore, displaying the virtual indicator reduces the need for physical markings or camera-guiding equipment (e.g., tracks) in the physical environment.

As represented by block 330b, in some implementations, the method 300 includes receiving a user input that corresponds to a modification of the target camera trajectory, and displaying a modified version of the target camera trajectory. For example, as shown in FIGS. 1D and 1E, the device 20 modifies the target camera trajectory 100 in response to detecting the drag input 110 and displays the modified target camera trajectory 100′.

As represented by block 330c, in some implementations, generating the target camera trajectory includes utilizing a generative model to generate the target camera trajectory based on the set of one or more estimated camera trajectories. In some implementations, the generative model accepts a model of the environment in which the new video is to be captured as an input and outputs the target camera trajectory. For example, the generative model accepts a mesh of the current environment and the estimated camera trajectory from the existing video as inputs, and outputs the target camera trajectory for a new video to be captured in the current environment. As another example, the generative model accepts a video of the current environment and the estimated camera trajectory from the existing video as inputs, and outputs the target camera trajectory for a new video to be captured in the current environment. In some implementations, the generative model is trained using the set of one or more estimated camera trajectories that were utilized to capture the existing video.

As represented by block 330d, in some implementations, generating the target camera trajectory for the new video includes selecting a subset of the set of one or more estimated camera trajectories that satisfy a suitability criterion associated with the environment in which the new video is to be captured and foregoing selection of a remainder of the set of one or more estimated camera trajectories that do not satisfy the suitability criterion associated with the environment in which the new video is to be captured. For example, referring to FIGS. 1N and 1O, the device 20 can automatically select the second target camera trajectory 160 in response to determining that the second target camera trajectory 160 has a greater suitability score than the target camera trajectory 100.

In some implementations, the suitability criterion indicates a dimension of the environment in which the new video is to be captured. In such implementations, generating the target camera trajectory includes selecting the subset of the set of one or more estimated camera trajectories in response to respective dimensions of estimated camera trajectories in the subset being less than the dimension of the environment, and forgoing selection of the remainder of the set of one or more estimated camera trajectories in response to respective dimensions of estimated camera trajectories in the remainder of the set being greater than the dimension of the environment. For example, the device selects a first estimated camera trajectory and forgoes selecting a second estimated camera trajectory in response to the first estimated camera trajectory fitting within bounds of the physical environment and the second estimated camera trajectory exceeding the bounds of the physical environment.

As represented by block 330e, in some implementations, the method 300 includes displaying a list of the set of one or more estimated camera trajectories that were utilized in the existing video, indicating that a subset of the set of estimated camera trajectories satisfies a suitability criterion associated with the environment of the new video and a remainder of the set of estimated camera trajectories do not satisfy the suitability criterion associated with the environment of the new video, and receiving a user input selecting one or more of the subset of the set of estimated camera trajectories that satisfies the suitability criterion. For example, as shown in FIG. 1O, the device 20 detects the user input 162 selecting the second target camera trajectory 160. The device may filter out camera trajectories with suitability scores that are below a threshold and allow the user to select from a remainder of the camera trajectories with suitability scores that are greater than the threshold.

In some implementations, the method 300 includes estimating camera settings of a camera that captured the existing video. For example, the device estimates a frame capture rate, a lens type, an exposure, flash status of the camera that captured the existing video and/or image filters that were applied during the capture of the existing video. In some implementations, the method 300 includes applying the same camera settings for the new video. For example, the device uses the same frame capture rate, lens type, exposure, flash status and/or image filters to capture the new video. In some implementations, the device varies some of the camera settings based on differences between the environment of the existing video and the environment of the new video. For example, if the current environment is overly bright, the device may turn the flash off even though the flash was on in the existing video. In some implementations, the camera includes a stereoscopic camera, and the settings include an interpupillary camera distance (IPD) and values related to spherical cameras, focal parameters and convergency parameters.

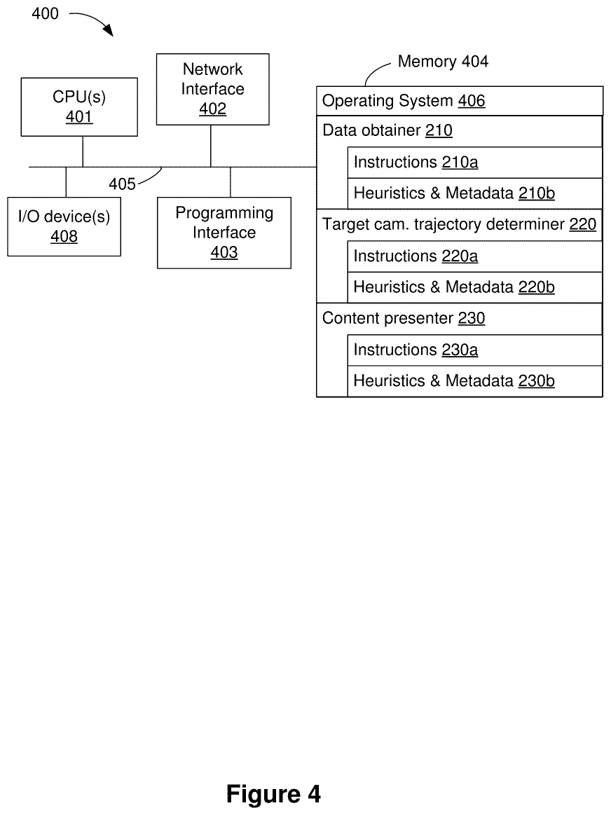

FIG. 4 is a block diagram of a device 400 in accordance with some implementations. In some implementations, the device 400 implements the device 20 shown in FIGS. 1A-1O and/or the system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 408, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the target camera trajectory determiner 220 and the content presenter 230. In various implementations, the device 400 performs the method 300 shown in FIG. 3.

In some implementations, the data obtainer 210 includes instructions 210a, and heuristics and metadata 210b for obtaining a request to generate a target camera trajectory for a new video that is to be captured in a current environment (e.g., the request 60 shown in FIGS. 1A-1B and/or the request 212 shown in FIG. 2). In some implementations, the instructions 210a, and heuristics and metadata 210b allow the data obtainer 210 to obtain a set of one or more estimated camera trajectories from an existing video (e.g., the estimated camera trajectory 90 shown in FIG. 1B and/or the estimated camera trajectories 216 shown in FIG. 2). In some implementations, the data obtainer 210 performs at least some of the operation(s) represented by blocks 310 and 320 in FIG. 3.

In some implementations, the target camera trajectory determiner 220 includes instructions 220a, and heuristics and metadata 220b for generating the target camera trajectory for the new video (e.g., the target camera trajectory 100 shown in FIGS. 1C-1D, the modified target camera trajectory 100′ shown in FIGS. 1E-1F, the modified target camera trajectory 100″ shown in FIG. 1G and/or the target camera trajectory 222 shown in FIG. 2). In some implementations, the target camera trajectory determiner 220 performs at least some of the operation(s) represented by block 330 in FIG. 3.

In some implementations, the content presenter 230 includes instructions 230a, and heuristics and metadata 230b for presenting a virtual indicator that indicates the target camera trajectory (e.g., the target camera trajectory 100 shown in FIGS. 1C-1D, the modified target camera trajectory 100′ shown in FIGS. 1E-1F and/or the modified target camera trajectory 100″ shown in FIG. 1G). In some implementations, the content presenter 230 performs at least some of the operation(s) represented by block 330 in FIG. 3.

In some implementations, the one or more I/O devices 408 include an input device for obtaining an input (e.g., the request 60 shown in FIGS. 1A-1B, the drag input 110 shown in FIG. 1D, the rotate input 120 shown in FIG. 1F, the user input 162 shown in FIG. 1O, and/or the request 212 shown in FIG. 2). In some implementations, the one or more I/O devices 408 include an environmental sensor for capturing environmental data (e.g., the environmental data 226 shown in FIG. 2). In some implementations, the one or more I/O devices 408 include one or more image sensors. For example, the one or more I/O devices 408 may include a rear-facing camera of a smartphone or a tablet for capturing images (e.g., a video). As another example, the one or more I/O devices 408 may include a scene-facing camera of an HMD for capturing images (e.g., a video). In some implementations, the one or more I/O devices 408 include a display for displaying a virtual indicator of a target camera trajectory determined by the target camera trajectory determiner 220 (e.g., the target camera trajectory 100 shown in FIGS. 1C-1D, the modified target camera trajectory 100′ shown in FIGS. 1E-1F and/or the modified target camera trajectory 100″ shown in FIG. 1G). In various implementations, the cameras mentioned herein include mono cameras or stereoscopic cameras.

In various implementations, the one or more I/O devices 408 include a video pass-through display which displays at least a portion of a physical environment surrounding the device 400 as an image captured by a camera (e.g., for displaying the camera GUI 130 shown in FIGS. 1H-1O). In various implementations, the one or more I/O devices 408 include an optical see-through display which is at least partially transparent and passes light emitted by or reflected off the physical environment (e.g., for displaying the target camera trajectory 100 shown in FIG. 1C).

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

Many camera-enabled devices include a camera application that presents a graphical user interface (GUI) in order to allow a user of the device to control the camera. A user of a camera-enabled device may want to capture a specific type of a cinematic shot but the user may not know how to operate the camera in order to capture that specific type of cinematic shot. For example, the user may want to capture an action shot but may not know where to set the camera, whether or not to move the camera, what exposure setting to use, etc.

The present disclosure provides methods, systems, and/or devices for displaying a cinematic shot guide that guides the user in capturing a set of cinematic shots. The user specifies a particular cinematic experience for an environment that the user wants to capture. For example, the user specifies that the user wants an action cinematic experience. The device obtains environmental characteristics of the environment and camera parameters of a set of available cameras. For example, the device determines dimensions of the environment, obstacles in the environment, a number of cameras that are available and functional capabilities of the available cameras. The device determines a set of target cinematic shots based on the environmental characteristics and the camera parameters. For example, the device determines to capture a low-angle push shot and a side tracking shot in order to generate the desired action cinematic experience. The device displays a cinematic shot guide that guides the user in capturing the target cinematic shot(s). The cinematic shot guide may include virtual objects that are overlaid onto a representation of the environment. For example, the cinematic shot guide indicates camera placement, camera trajectory, camera settings, etc.

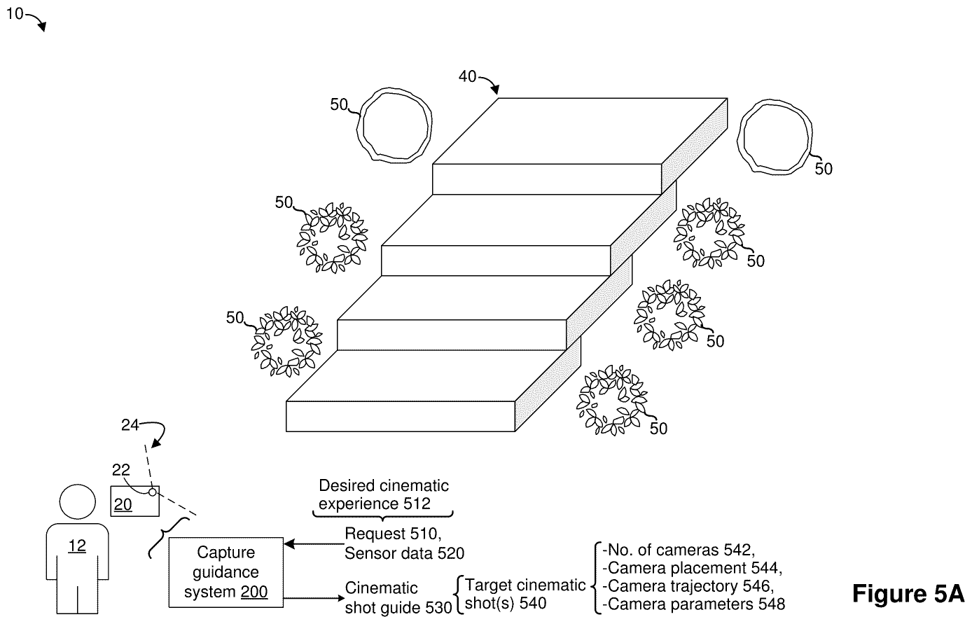

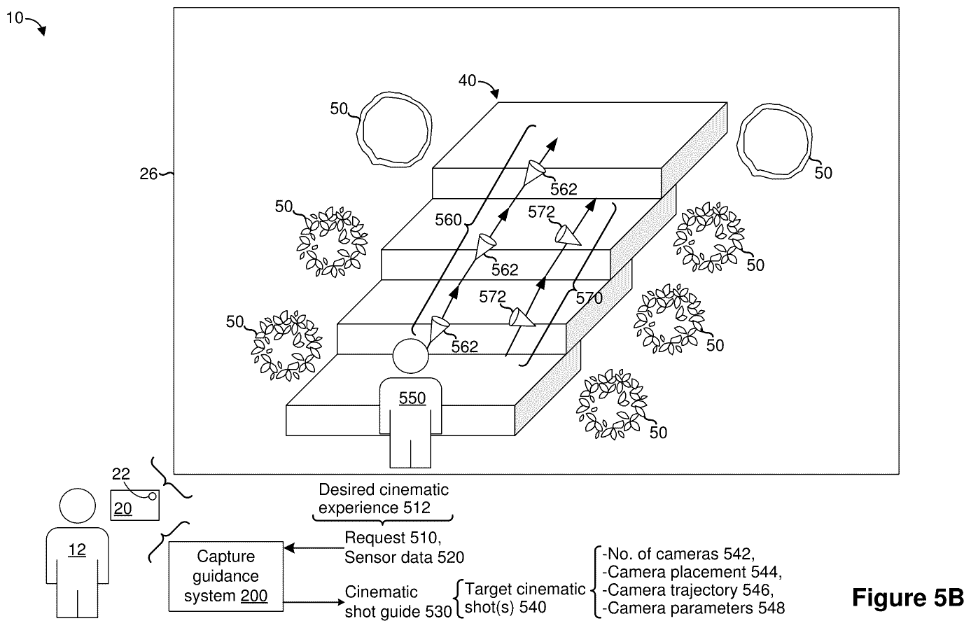

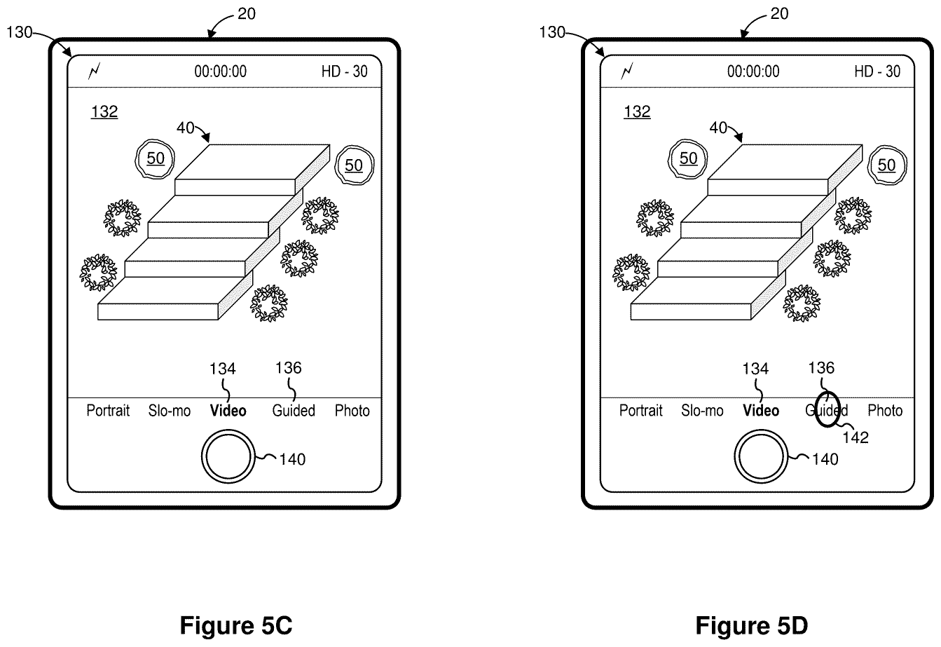

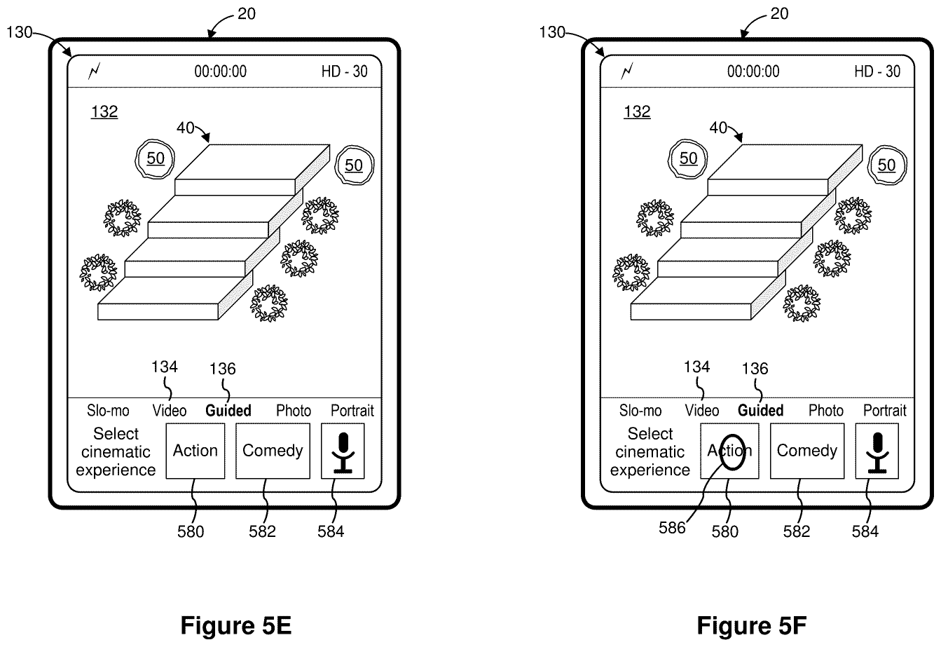

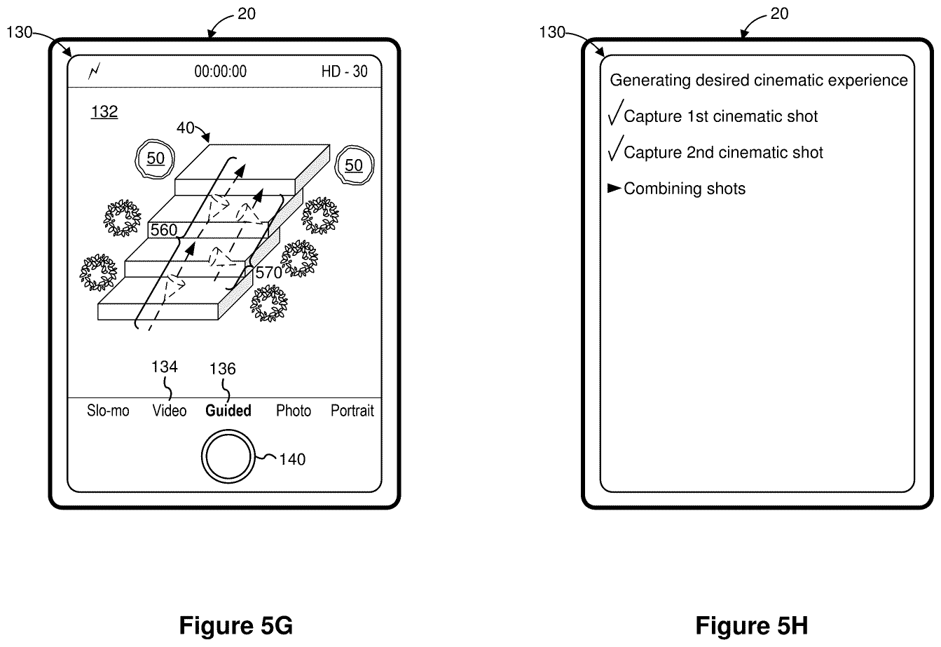

Referring to FIG. 5A, the system 200 receives a request 510 for capturing the physical environment 10 in a way that provides a desired cinematic experience 512. In some implementations, the device 20 receives a selection of the desired cinematic experience 512 from a list of predefined cinematic experiences such as action, comedy, suspense, horror, sports, etc. Alternatively, in some implementations, the device 20 receives a user input that describes the desired cinematic experience 512. For example, the user 12 specifies that he/she wants to capture a video of the physical environment 10 in the same manner as a particular scene from a specified movie.

The device 20 obtains sensor data 520 from various sensors. In some implementations, the sensor data 520 includes image data from the camera 22 and/or depth data from a depth sensor. The sensor data 520 characterizes the physical environment 10. For example, the sensor data 520 indicates dimensions of the physical environment 10 and/or obstacles in the physical environment 10. In the example of FIG. 5A, the sensor data 520 indicates that the physical environment 10 includes the stairs 40 and the plants 50.

In some implementations, the sensor data 520 indicates filming equipment that is available for capturing the desired cinematic experience 512. For example, the sensor data 520 indicates a number of cameras that are available, characteristics of the available cameras, trolleys and tracks for capturing moving shots, lighting equipment for lighting the physical environment 10 and/or sound equipment for capturing sounds in the physical environment 10.

In some implementations, the system 200 determines a set of target cinematic shots 540 that collectively provide the desired cinematic experience 512. The system 200 determines the target cinematic shot(s) 540 based on environmental characteristics and cinematic equipment characteristics indicated by the sensor data 520. For example, the system 200 selects the target cinematic shot(s) 540 based on dimensions of the physical environment 10, obstacles in the physical environment 10 and available filming equipment. To that end, the target cinematic shot(s) 540 indicates a number of cameras 542 that are to be used in capturing the target cinematic shot(s) 540, camera placement 544 for the camera(s), camera trajectory 546 for camera(s) that will be used in a moving shot and camera parameter values 548 such as zoom value, exposure time, etc.

In some implementations, the system 200 selects the target cinematic shot(s) 540 from a set of predefined cinematic shots based on the environmental characteristics and the cinematic equipment characteristics indicated by the sensor data 520. In some implementations, the system 200 forgoes selecting a predefined cinematic shot that may not be feasible or may be difficult to capture due to the obstacles in the physical environment 10. For example, the system 200 forgoes selecting a trolley shot (e.g., a push shot or a pull shot) due to the stairs 40 in the physical environment 10 and the relative difficulty in setting up a track on the stairs 40.

Referring to FIG. 5B, the system 200 displays the cinematic shot guide 530 on the display 26. In the example of FIG. 5B, the cinematic shot guide 530 includes a first visual indication of a first target cinematic shot 560 that corresponds to a low angle ascending shot and a second visual indication of a second target cinematic shot 570 that corresponds to a side tracking shot. As indicated by a first set of cones 562, during the first target cinematic shot 560, the camera points upwards towards a top of the stairs while the camera is moved from a bottom of the stairs 40 to the top of the stairs as indicated by the arrows. Capturing the first target cinematic shot 560 results in a first video that corresponds to the low angle ascending shot. As indicated by a second set of cones 572, during the second target cinematic shot 570, the camera points sideways towards the subject 550 as the subject 550 and the camera ascend towards the top of the stairs 40. Capturing the second target cinematic shot 570 results in a second video that corresponds to the side tracking shot.

The system 200 combines resulting videos from the target cinematic shots 560 and 570 to generate the desired cinematic experience 512. For example, the system 200 combines the first video and the second video to generate a third video that includes a portion of the low angle ascending shot from the first video and a portion of the side tracking shot from the second video. As an example, the third video may start with the low angle ascending shot from the first video as the subject 550 ascends the first stair, the third video then switches to the side tracking shot from the second video as the subject 550 ascends the second and third stairs, and the third video finally switches back to the low angle ascending shot from the first video as the subject 550 climbs the fourth and final stair.

While the example of FIG. 5B shows how the system 200 can combine two different cinematic shots to deliver the desired cinematic experience 512, in some implementations, the system 200 combines additional shots to deliver the desired cinematic experience 512. For example, the system 200 may suggest using a drone fitted with a camera to capture a top-down shot of the subject 550 as the subject ascends the stairs 40. In this example, the system 200 may incorporate a video corresponding to the top-down shot into the resultant video.

FIG. 5C-5H illustrate example user interfaces for generating and displaying a cinematic shot guide for a desired cinematic experience. FIG. 5C shows the camera GUI 130 explained in detail with respect to FIG. 1H. FIG. 5D shows the user input 142 directed to the guided option 136 as explained in detail with respect to FIG. 1I. As shown in FIG. 5E, in response to detecting the user input 142 directed to the guided option 136, the camera GUI 130 displays various affordances to select a desired cinematic experience.

As shown in FIG. 5E, the camera GUI 130 displays an action affordance 580 for selecting an action cinematic experience, a comedy affordance 582 for selecting a comedic cinematic experience and a mic affordance 584 for describing another cinematic experience that the user wants to capture. Selecting the action affordance 580 corresponds to a request to present a cinematic shot guide for capturing a set of one or more action cinematic shots that are combined to generate an action cinematic experience. Similarly, selecting the comedy affordance 582 corresponds to a request to present a cinematic shot guide for capturing a set of one or more comedic cinematic shots that are combined to generate a comedic cinematic experience. In some implementations, the camera GUI 130 allows the user to scroll through respective affordances for various predefined cinematic experiences. For example, the camera GUI may allow the user to scroll through a list of predefined cinematic experiences including a horror cinematic experience, a sports cinematic experience, a suspense cinematic experience, a celebration cinematic experience, etc.

In the example of FIG. 5F, the device 20 detects a user input 586 directed to the action affordance 580. The user input 586 corresponds to a request to display a cinematic shot guide that guides the user in capturing a set of one or more target cinematic shots that collectively deliver the action cinematic experience. FIG. 5G shows the cinematic shot guide with the first target cinematic shot 560 and the second target cinematic shot 570 that are described in detail with respect to FIG. 5B.

FIG. 5H is a diagram of the camera GUI 130 showing progress in generating the desired cinematic experience. As indicated by two checkmarks shown in FIG. 5H, the first and second cinematic shots have been captured. For example, the user 12 has captured a first video corresponding to the first target cinematic shot 560 and a second video corresponding to the second target cinematic shot 570 shown in FIGS. 5B and 5G. As indicated by a triangle, the device 20 and/or the system 200 are currently combining the first and second cinematic shots in order to generate a video that includes selective portions from each of the first and second target cinematic shots 560 and 570. For example, the device 20 and/or the system 200 is generating a third video that combines portions of the first video that corresponds to the first target cinematic shot and the second video that corresponds to the second target cinematic shot.

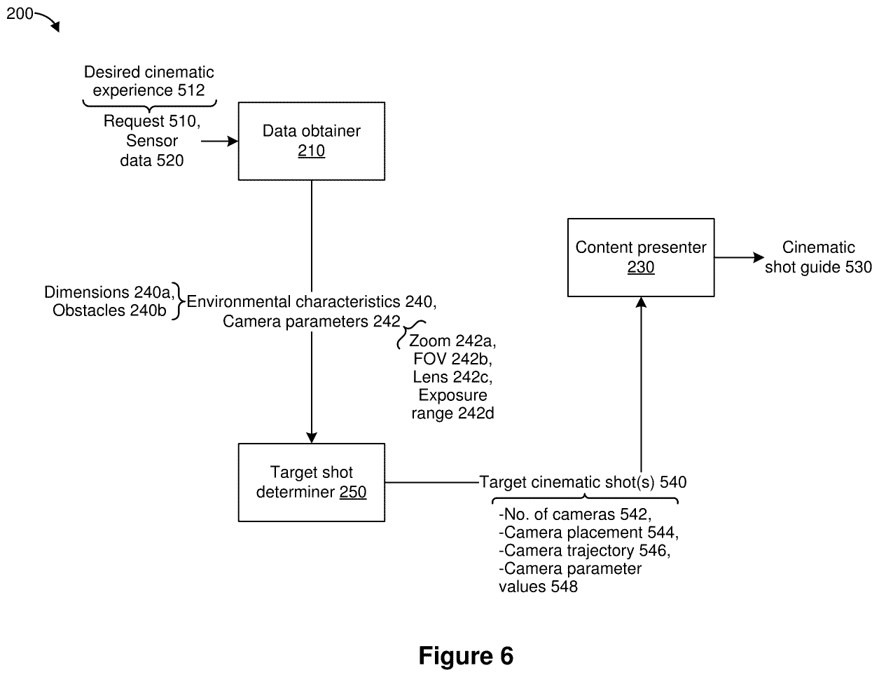

FIG. 6 illustrates a block diagram of the system 200 in accordance with some implementations. In some implementations, the system 200 includes the data obtainer 210, the content presenter 230 and a target shot determiner 250. In various implementations, the data obtainer 210 obtains the request 510 specifying the desired cinematic experience 512 and the sensor data 520. In some implementations, the data obtainer 210 receives the request 510 via the camera GUI 130 shown in FIGS. 5C-5F. In some implementations, the data obtainer 210 receives the sensor data 520 from various sensors of the device 20.

In some implementations, the sensor data 520 indicates environmental characteristics 240 of the physical environment. For example, in some implementations, the environmental characteristics 240 include dimensions 240a of the physical environment. In some implementations, the environmental characteristics indicate obstacles 240b in the physical environment (e.g., furniture, supporting pillars, etc.). In some implementations, the data obtainer 210 determines the environmental characteristics 240 based on image data and/or sensor data included in the sensor data 520. For example, the data obtainer 210 determines the environmental characteristics 240 by performing an image analysis of the image data. The data obtainer 210 provides information regarding the environmental characteristics 240 to the target shot determiner 250.

In some implementations, the sensor data 520 indicates camera parameters 242 of cameras that are available for filming the desired cinematic experience 512. In some implementations, the camera parameters 242 indicate functional capabilities of the cameras. In some implementations, the camera parameters 242 indicate a zoom level 242a of the cameras. In some implementations, the camera parameters 242 indicate a field of view (FOV) 242b of the cameras. In some implementations, the camera parameters 242 indicate a type of lens 242c of the cameras. In some implementations, the camera parameters 242 indicate an exposure range 242d of the cameras. In some implementations, the data obtainer 210 determines the camera parameters 242 based on the sensor data 520. Alternatively, and some implementations, the data obtainer 210 determines the camera parameters 242 based on user input provided by the user. For example, the user may specify the camera parameters 242 via a graphical user interface (e.g., via the camera GUI 130 shown in FIGS. 5C-5H). The data obtainer 210 provides the camera parameters 242 to the target shot determiner 250.

In various implementations, the sensor data 520 indicates equipment characteristics of filming equipment that is available for capturing the desired cinematic experience 512. For example, the sensor data 520 indicates camera availability (e.g., a number of cameras, types of cameras and/or features of the cameras), lighting equipment availability (e.g., types of light, light colors, light intensities, etc.), microphone availability (e.g., number of MICs, MIC types, etc.), rigs that are available for filming the desired cinematic experience 512 (e.g., trolleys, carts, tracks, etc.) and other equipment that may be used in capturing a cinematic shot. In some implementations, the data obtainer 210 determines the equipment characteristics based on the sensor data 520. Alternatively, and some implementations, the data obtainer 210 determines the equipment characteristics based on user input provided by the user. For example, the user may specify the equipment characteristics via a graphical user interface (e.g., via the camera GUI 130 shown in FIGS. 5C-5H). The data obtainer 210 provides the equipment characteristics to the target shot determiner 250.

In various implementations, the target shot determiner 250 determines the target cinematic shot(s) 540 based on the environmental characteristics 240, the camera parameters 242 and/or the equipment characteristics provided by the data obtainer 210. In some implementations, the target shot determiner 250 utilizes a machine learned model to determine the target cinematic shots 540. In such implementations, the machine learned model accepts the environmental characteristics 240, the camera parameters 242 and/or the equipment characteristics as inputs, and outputs indications of the target cinematic shots 540. In some implementations, the machine learned model is trained to output the target cinematic shots 540 using training data that includes previously captured video and associated environmental characteristics, camera parameters and equipment characteristics.

In some implementations, the content presenter 230 generates and displays the cinematic shot guide 530 based on the target cinematic shots 540 provided by the target shot determiner 250. In some implementations, the cinematic shot guide 530 includes step by step instructions for the user to follow in order to capture the target cinematic shots 540. For example, as shown in FIG. 5G, the cinematic shot guide 530 includes visual markings with arrows and cones for each cinematic shot that is to be captured. In some implementations, the cinematic shot guide 530 provides guidance while a particular cinematic shot is being captured. For example, referring to FIG. 1M, the cinematic shot guide 530 displays the speed guidance 152 which tells the user to slow down when the user is moving too fast. In some implementations, presenting the cinematic shot guide 530 includes making automatic adjustments to the filming equipment while a particular cinematic shot is being captured. For example, the device automatically increases a brightness of a light source as a camera traverses through a dimly lit portion of the environment.

In various implementations, the content presenter 230 combines multiple shots captured by the user in order to generate a resulting video that corresponds to the desired cinematic experience. For example, as shown in FIG. 5H, the content presenter 230 combines the first video corresponding to the first target cinematic shot 560 with the second video corresponding to the second target cinematic shot 570 in order to generate a resultant third video that includes portions of two different types of shots. In some implementations, the content presenter 230 combines multiple shots by interlacing the shots together so that the resultant video shows switching back and forth between multiple shots.

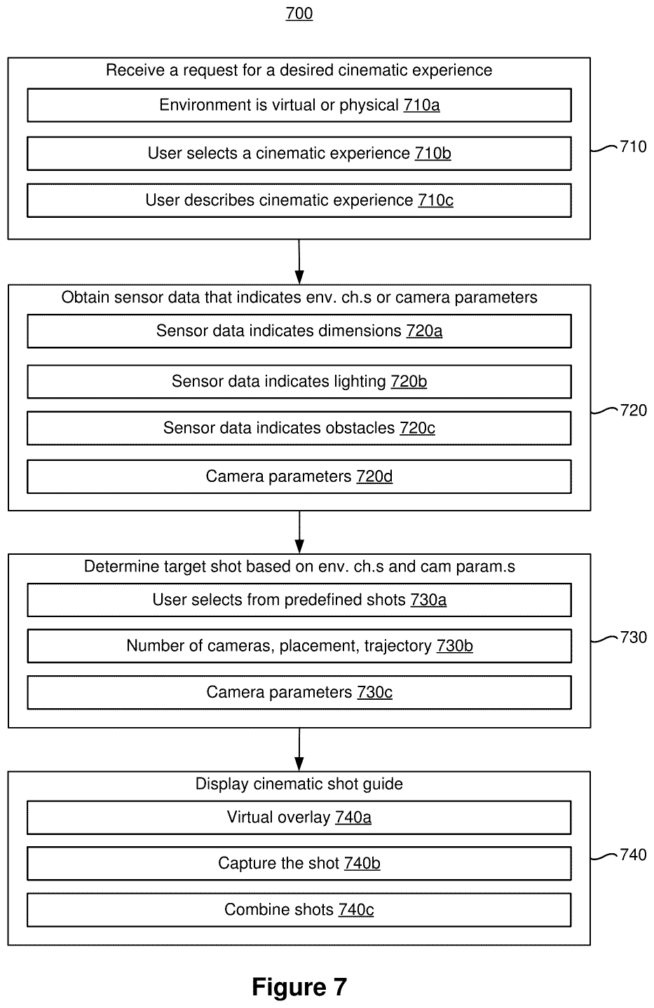

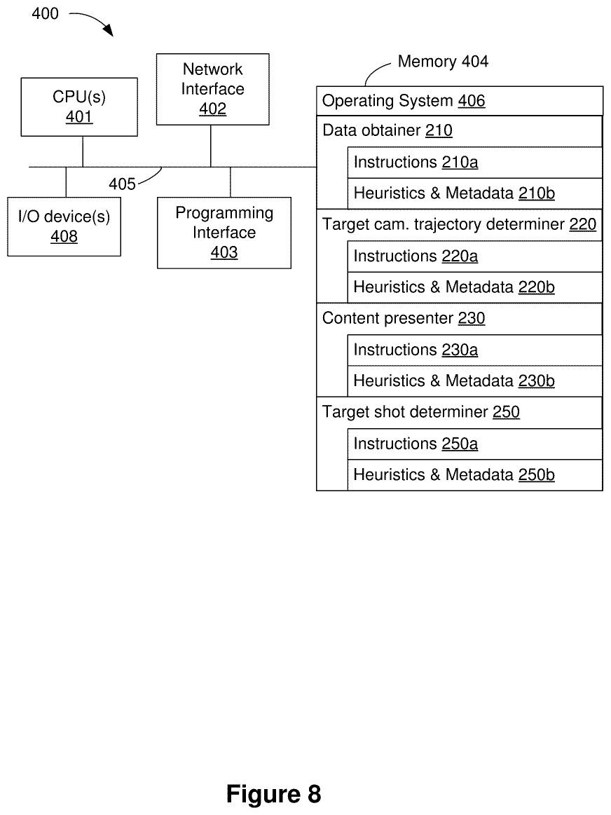

FIG. 7 illustrates a method 700 for presenting a cinematic shot guide for generating a desired cinematic experience. In various implementations, the method 700 is performed by the device 20 and/or the system 200 shown in FIGS. 5A and 5B. As represented by block 710, in some implementations, the method 700 includes receiving a request that specifies a desired cinematic experience for an environment. For example, as shown in FIG. 5A, the device 20 receives the request 510 for the desired cinematic experience 512.

As represented by block 710a, in some implementations, the environment includes a physical environment or a virtual environment. In the example of FIGS. 5A and 5B, the environment is the physical environment 10. However, in some implementations, the environment is a virtual environment (e.g., an entirely or partially simulated environment).

As represented by block 710b, in some implementations, receiving the request comprises displaying a plurality of potential cinematic experiences and receiving a user input selecting one of the potential cinematic experiences. For example, as shown in FIG. 5E, the camera GUI 130 displays the affordances 580 and 582 for different predefined cinematic experiences. The user can indicate his/her preference for the desired cinematic experience by selecting one of the predefined cinematic experiences. As shown in FIG. 5F, the user selects the action cinematic experience. In some implementations, the method 700 includes displaying a list of iconic (e.g., memorable) scenes from movies and the user selects one of the scenes from the movies to model the current cinematic experience after.

As represented by block 710c, in some implementations, receiving the request comprises receiving a user prompt that specifies the desired cinematic experience. For example, the user provides a voice input specifying that he/she wants to capture a shot that is similar to a scene in a particular movie. As shown in FIG. 5E, the camera GUI 130 includes a mic affordance 584 that the user can press to start speaking. The user's speech input is parsed to identify the desired cinematic experience.

As represented by block 720, in some implementations, the method 700 includes obtaining sensor data that indicates environmental characteristics of the environment and camera parameters of a set of one or more cameras. For example, as shown in FIG. 6, the data obtainer 210 obtains the sensor data 520 that indicates the environmental characteristics 240 and the camera parameters 242. In some implementations, the method 700 includes obtaining image data and/or depth data, and determining the environmental characteristics based on the image data and/or the depth data. In some implementations, the method 700 includes receiving a user input that corresponds to the camera parameters and/or filming equipment. For example, the user specifies what equipment the user has for filming the desired cinematic experience.

As represented by block 720a, in some implementations, the sensor data comprises image data or depth data that indicates dimensions of the environment. For example, as shown in FIG. 6, the environmental characteristics 240 include the dimensions 240a. In some implementations, the method 700 includes determining the target cinematic shot(s) based on the dimensions of the environment. For example, the device determines a zoom level for a shot based on a width of the environment.

As represented by block 720b, in some implementations, the sensor data comprises ambient light data that indicates lighting conditions in the environment. For example, referring to FIG. 6, in some implementations, the environmental characteristics 240 include the lighting information for the environment (e.g., light colors, shadows cast by light, light intensity, etc.). In some implementations, the method 700 includes determining the target cinematic shot(s) based on the lighting conditions. For example, the device determines placement locations for lighting equipment based on the lighting conditions, for example, so that the environment is appropriately lit for the target cinematic shot.

As represented by block 720c, in some implementations, the sensor data comprises image data or depth data that indicates obstructions in the environment. For example, as shown in FIG. 6, the environmental characteristics 240 indicate the obstacles 240b in the environment. In some implementations, the method 700 includes determining the target cinematic shot(s) based on the obstacles. For example, the device determines camera trajectories that navigate around the obstacles.

As represented by block 720d, in some implementations, the camera parameters comprise one or more of a number of cameras, moveability of cameras, zoom capability and a field-of-view (FOV) size. For example, as shown in FIG. 6, the camera parameters 242 include the zoom level 242a, the FOV 242b, the lens 242c and the exposure range 242d. Furthermore, as shown in FIG. 6, the target cinematic shot is defined by the number of cameras 542, the camera placement 544, the camera trajectory 546 and the camera parameter values 548.

As represented by block 730, in some implementations, the method 700 includes determining, based on the environmental characteristics and the camera parameters, a target cinematic shot that provides the desired cinematic experience. For example, as shown in FIG. 5B, the system 200 determines the target cinematic shots 560 and 570 based on the environmental characteristics and camera parameters indicated by the sensor data 520. In various implementations, determining the target cinematic shot based on the environmental characteristics helps ensure that the target cinematic shot is appropriate for (e.g., tailored to) the environment. In various implementations, determining the target cinematic shot based on the camera parameters and/or the filming equipment characteristics helps ensure that the target cinematic shot is feasible (e.g., possible with the available filming equipment).

As represented by block 730a, in some implementations, determining the target cinematic shot comprises selecting the target cinematic shot from a set of predefined cinematic shots associated with corresponding environmental characteristic values and camera parameter values. For example, referring to FIGS. 5B and 5G, the device 20 and/or the system 200 select the first target cinematic shot 560 that corresponds to the low angle ascending shot and the second target cinematic shot 570 that corresponds to the side tracking shot from a list of predefined shots including a low angle ascending shot (e.g., a dolly-based low angle ascending shot or a drone-based low angle ascending shot), an overhead top-down shot, a side tracking shot (e.g., a parallel motion shot), a spiral crane shot (e.g., an orbiting shot), a first-person point-of-view (POV) climbing shot, a reverse tracking shot (e.g., a pullback reveal shot), a slow-motion petal drift shot (e.g., a macro close-up shot), a tilted Dutch angle shot and a reverse jump-cut stair ascent shot.

As represented by block 730b, in some implementations, determining the target cinematic shot includes selecting a number of cameras to use while capturing the target cinematic shot. For example, as shown in FIGS. 5B and 6, the target shot determiner 250 determines the number of cameras 542 that are to be used in filming the target cinematic shot(s) 540. In some implementations, determining the target cinematic shot comprises determining a camera placement location. For example, as shown in FIG. 6, the target shot determiner 250 determines the camera placement 544 for the target cinematic shot(s) 540. In some implementations, determining the target cinematic shot comprises determining a camera trajectory for a moving camera. For example, as shown in FIG. 6, the target shot determiner 250 determines the camera trajectory 546 for the target cinematic shot(s) 540 (e.g., paths indicated by arrows and cones in FIG. 5B).

As represented by block 730c, in some implementations, determining the target cinematic shot comprises determining a camera parameter value. For example, as shown in FIG. 6, the target shot determiner 250 determines the camera parameter values 548 for at least some of the camera parameters 242. In some implementations, determining the camera parameter value comprises determining one or more of an exposure time (e.g., a shutter speed), an aperture setting (e.g., an f-stop value), an ISO setting value, a white balance setting, a focus mode (e.g., continuous autofocus for moving objects or single autofocus for static objects), a frame rate for video, an image stabilization setting (e.g., enable or disable image stabilization in response to detecting tripod usage), compression level (e.g., based on amount of image data that is to be captured) and flash intensity (e.g., an adjustment to a flash power).

As represented by block 740, in some implementations, the method 700 includes displaying a cinematic shot guide for capturing the target cinematic shot. For example, as shown in FIGS. 5B, 5G and 6, the device 20, the system 200 and/or the content presenter 230 generate and display the cinematic shot guide 530. In various implementations, displaying the cinematic shot guide provides guidance to a user of the device in capturing a set of one or more target cinematic shots that collectively deliver the desired cinematic experience. Displaying the cinematic shot guide allows the user to use the camera and other filming equipment correctly so as to avoid trial-and-error thereby reducing power consumption of the device resulting from repeated takes of the same shot.

As represented by 740a, in some implementations, displaying the cinematic shot guide comprises overlaying a set of virtual objects onto the environment in order to guide a user of the device in capturing the target cinematic shot. For example, as shown in FIG. 5B, the device 20 and/or the system 200 displays the cinematic shot guide 530 by overlaying, onto a pass-through representation of the physical environment 10, virtual arrows and cones that indicate the first target cinematic shot 560 and the second target cinematic shot 570.

As represented by block 740b, in some implementations, the method 700 includes capturing the target cinematic shot as a user follows the cinematic shot guide. For example, referring to FIG. 5G, the device 20 captures a first video as the user of the device 20 follows a first path indicated by the first target cinematic shot 560 and a second video as the user follows a second path indicated by the second target cinematic shot 570.

As represented by block 740c, in some implementations, the method 700 includes combining shots captured by multiple cameras to create a single video that conforms to the target cinematic shot. For example, as shown in FIG. 5H, the device 20 combines multiple videos corresponding to different cinematic shots in order to generate the desired cinematic experience. In some implementations, the device interweaves the videos together so that the resultant video shows multiple transitions between different types of cinematic shots.

Referring to FIG. 8, in various implementations, the device 400 additionally includes the target shot determiner 250. The target shot determiner 250 includes instructions 250a, and heuristics and metadata 250b for determining a set of one or more target cinematic shots (e.g., the target cinematic shots 560 and 570 shown in FIG. 5B). In various implementations, the data obtainer 210 performs the operations associated with blocks 710 and 720 shown in FIG. 7. The target shot determiner 250 performs the operations associated with block 730 shown in FIG. 7. The content presenter 230 performs the operations associated with block 740 shown in FIG. 7.

Persons of ordinary skill in the art will appreciate that the device 400 (e.g., the target camera trajectory determiner 220, the content presenter 230 and/or the target shot determiner 250) can include any suitable machine learning models that are well-known or widely available such as regression techniques, classification techniques, neural networks, and deep learning networks. For instance, the device 400 can include neural networks such as Artificial Neural Network (ANN), Convolutional Neural Network (CNN), Recurrent Neural Network (RNN), Adversarial Network (GAN), Reinforcement Learning Model (RLM), Encoder/Decoder Networks, and/or Transformer-Based Models (e.g., Bidirectional Encoder Representations from Transformers (BERT), Generative Pre-trained Transformer (GPT), and/or a multi-modal large language model (LLM)). Additionally or alternatively, persons of ordinary skill in the art will appreciate that the device 400 can be any suitable non-learning processes such as rule-based systems, heuristics, decision trees, knowledge-based systems, statistical or stochastic systems, and expert systems.

In some embodiments, components of the device 400 (e.g., the target camera trajectory determiner 220, the content presenter 230 and/or the target shot determiner 250) can be deployed as one or more generative models, where content (e.g., the virtual indicator 232 shown in FIG. 2 and/or the cinematic shot guide 530 shown in FIG. 6) is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content. Automatically-generated content optionally includes deterministically generated content that is generated by one or more computer systems and/or non-deterministically generated content that is generated automatically by one or more computer systems.

In some embodiments, automatically-generated content that is generated using a non-deterministic process is referred to as generative content (e.g., generative images, generative graphics, generative video, generative audio, and/or generative text). Generative content is typically generated by an automated process based on a prompt that is provided to the automated process. In some embodiments, the automated process is a Machine Learning (ML) process. An ML process typically uses one or more ML models to generate an output based on an input. An ML process optionally includes one or more pre-processing steps to adjust the input before it is used by the ML model to generate an output (e.g., adjustment to a user-provided prompt, creation of a system-generated prompt, and/or ML model selection). Generative content can, in some embodiments, be generated using a non-deterministic process that generates content using one or more automatic steps that include specific rules and steps for processing a prompt including one or more non-deterministic steps that introduce novel generative elements into the content that is generated. An ML process optionally includes one or more post-processing steps to adjust the output by the ML model (e.g., passing ML model output to a different ML model, upscaling, downscaling, cropping, formatting, and/or adding or removing metadata) before the output of the ML model used for other purposes such as being provided to a different software process for further processing or being presented (e.g., visually or audibly) to a user. An ML process that generates generative content is sometimes referred to as a generative ML process.

A prompt for generating generative content can include one or more of: one or more words (e.g., a natural language prompt that is written or spoken), one or more images, one or more drawings, and/or one or more videos. ML processes can include neural networks, linear regression, decision trees, support vector machines (SVMs), Naive Bayes, and k-nearest neighbors. Neural networks can include transformer-based deep neural networks such as large language models (LLMs) that are trained using supervised, unsupervised, reinforcement, and/or other learning techniques. Generative pre-trained transformer models are a type of LLM that can be effective at generating novel generative content based on a prompt. Some ML processes use a prompt that includes text to generate either different generative text, generative audio content, and/or generative visual content. Some ML processes use a prompt that includes visual content and/or an audio content to generate generative text (e.g., a transcription of audio and/or a description of the visual content). Some multi-modal ML processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an ML process that include phrasing, a specified style, relevant context (e.g., starting point content and/or one or more examples), and/or a role for the ML process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseudo-random seed content is used as a starting point for creating the generative content). For example when generating an image from a diffusion model, a random noise pattern is iteratively denoised based on the prompt to generate an image that is based on the prompt. While specific types of ML processes have been described herein, it should be understood that a variety of different ML processes could be used to generate generative content based on a prompt.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data by the device 400 can be used to benefit users. For example, the data can be used to train models that can be deployed to improve performance, accuracy, and/or functionality of applications and/or services. Accordingly, the use of the data enables the device 400 to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data by the device 400 are also contemplated by the present disclosure.

The present disclosure contemplates that, in some embodiments, data used by the device 400 includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used by the device 400, should attempt to comply with well-established privacy policies and/or privacy practices.

For example, such entities may implement and consistently follow policies and practices recognized as meeting or exceeding industry standards and regulatory requirements for developing and/or training the device 400. In doing so, attempts should be made to ensure all intellectual property rights and privacy considerations are maintained. Training should include practices safeguarding training data, such as personal information, through sufficient protections against misuse or exploitation. Such policies and practices should cover all stages of the development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, the device 400 may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used by the device 400 may be kept strictly separated from platforms where processes are deployed and/or used to interact with users and/or process data. In such embodiments, data used for offline training of the processes may be maintained in secured datastores with restricted access and/or not be retained beyond the duration necessary for training purposes. In some embodiments, the device 400 may utilize a local memory cache to store data temporarily during a user session. The local memory cache may be used to improve performance of the device 400. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use by the device 400. The media capture guidance processes should be monitored for changes in underlying data distribution such as concept drift or data skew that can degrade performance of the media capture guidance processes over time.

In some embodiments, the media capture guidance processes are trained using a combination of offline and online training. Offline training can use curated datasets to establish baseline model performance, while online training can allow the media capture guidance processes to continually adapt and/or improve. The present disclosure recognizes the importance of maintaining strict data governance practices throughout this process to ensure user privacy is protected.

In some embodiments, the media capture guidance processes may be designed with safeguards to maintain adherence to originally intended purposes, even as the media capture guidance processes adapt based on new data. Any significant changes in data collection and/or applications of media capture guidance process use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the media capture guidance processes and/or for use as input during the inference stage of such systems. In yet another example, the present technology should be configured to allow users to be able to select to limit the length of time data is maintained or entirely prohibit the use of their data for use by the media capture guidance processes. In addition to providing “opt in” and “opt out” options, the present disclosure contemplates providing notifications relating to the access or use of personal information. For instance, a user can be notified when their data is being input into the media capture guidance processes for training or inference purposes, and/or reminded when the media capture guidance processes generate outputs or make decisions based on their data.

The present disclosure recognizes media capture guidance processes should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the media capture guidance processes. Generated content can be filtered for potentially inappropriate or dangerous material prior to being presented to users, while human oversight and/or ability to override or correct erroneous or undesirable outputs can be maintained as a failsafe.

The present disclosure further contemplates that users of the media capture guidance processes should refrain from using the services in any manner that infringes upon, misappropriates, or violates the rights of any party. Furthermore, the media capture guidance processes should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The media capture guidance processes should not violate, misappropriate, or infringe any copyrights, trademarks, rights of privacy and publicity, trade secrets, patents, or other proprietary or legal rights of any party, and appropriately attribute content as required. Further, the media capture guidance processes should not interfere with any security, digital signing, digital rights management, content protection, verification, or authentication mechanisms. The media capture guidance processes should not misrepresent machine-generated outputs as being human-generated.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a display, an image sensor, non-transitory memory and one or more processors:
receiving a request that specifies a desired cinematic experience for an environment;
obtaining sensor data that indicates environmental characteristics of the environment and camera parameters of a set of one or more cameras;
determining, based on the environmental characteristics and the camera parameters, a target cinematic shot that provides the desired cinematic experience; and
displaying a cinematic shot guide for capturing the target cinematic shot.

2. The method of claim 1, wherein determining the target cinematic shot comprises selecting the target cinematic shot from a set of predefined cinematic shots associated with corresponding environmental characteristic values and camera parameter values.

3. The method of claim 1, wherein determining the target cinematic shot includes selecting a number of cameras to use while capturing the target cinematic shot.

4. The method of claim 1, wherein determining the target cinematic shot comprises determining a camera placement location.

5. The method of claim 1, wherein determining the target cinematic shot comprises determining a camera trajectory for a moving camera.

6. The method of claim 1, wherein determining the target cinematic shot comprises determining a camera parameter value.

7. The method of claim 6, wherein determining the camera parameter value comprises determining one or more of an exposure time, an aperture setting, an ISO setting value, a white balance setting, a focus mode, a frame rate for video, an image stabilization setting, compression level and flash intensity.

8. The method of claim 1, wherein displaying the cinematic shot guide comprises overlaying a set of virtual objects onto the environment in order to guide a user of the device in capturing the target cinematic shot.

9. The method of claim 1, further comprising capturing the target cinematic shot as a user follows the cinematic shot guide.

10. The method of claim 1, further comprising combining shots captured by multiple cameras to create a single video that conforms to the target cinematic shot.

11. The method of claim 1, wherein the sensor data comprises image data or depth data that indicates dimensions of the environment.

12. The method of claim 1, wherein the sensor data comprises ambient light data that indicates lighting conditions in the environment.

13. The method of claim 1, wherein the sensor data comprises image data or depth data that indicates obstructions in the environment.

14. The method of claim 1, wherein the camera parameters comprise one or more of a number of cameras, moveability of cameras, zoom capability and a field-of-view (FOV) size.

15. The method of claim 1, wherein the environment includes a physical environment or a virtual environment.

16. The method of claim 1, wherein receiving the request comprises displaying a plurality of potential cinematic experiences and receiving a user input selecting one of the potential cinematic experiences.

17. The method of claim 1, wherein receiving the request comprises receiving a user prompt that specifies the desired cinematic experience.

18. A device comprising:
one or more processors;
an image sensor;
a display;
a non-transitory memory; and
one or more programs stored in the non-transitory memory, which, when executed by the one or more processors, cause the device to:
receive a request that specifies a desired cinematic experience for an environment;
obtain sensor data that indicates environmental characteristics of the environment and camera parameters of a set of one or more cameras;
determine, based on the environmental characteristics and the camera parameters, a target cinematic shot that provides the desired cinematic experience; and
display a cinematic shot guide for capturing the target cinematic shot.

19. A non-transitory memory storing one or more programs, which, when executed by one or more processors of a device including a display and an image sensor, cause the device to:
receive a request that specifies a desired cinematic experience for an environment;
obtain sensor data that indicates environmental characteristics of the environment and camera parameters of a set of one or more cameras;
determine, based on the environmental characteristics and the camera parameters, a target cinematic shot that provides the desired cinematic experience; and
display a cinematic shot guide for capturing the target cinematic shot.

20. The non-transitory memory of claim 19, wherein determining the target cinematic shot comprises selecting the target cinematic shot from a set of predefined cinematic shots associated with corresponding environmental characteristic values and camera parameter values.
